(19) United States
(12) Patent Application Publication
(10) Pub. No.: US 2009/0019523 A1
(43) Pub. Date: Jan. 15, 2009

(54) CONTROLLING NETWORK COMMUNICATIONS

(75) Inventors: Seiji TAKAHASHI, Tokyo (JP); Hiroki OHZAKI, Kanagawa (JP)

Correspondence Address: COOPER & DUNHAM, LLP, 1185 AVENUE OF THE AMERICAS, NEW YORK, NY, 10036, US

(73) Assignee: RICOH COMPANY, LTD.

(21) Appl. No.: 12/139,090

(22) Filed: Jun. 13, 2008

(30) Foreign Application Priority Data
Jun. 15, 2007 (JP) JP2007-159009

(51) Int. Cl. G06F 21/00

(52) U.S. Cl. 726/3

(57) ABSTRACT

A technique of establishing communication between a server apparatus and a client apparatus in a manner that satisfies a desired security level of network communications is disclosed.

### CROSS-REFERENCE TO RELATED APPLICATIONS

This patent application is based on and claims priority under 35 U.S.C. § 119 to Japanese Patent Application No. 2007-159009, filed on Jun. 15, 2007, in the Japanese Patent Office, the disclosure of which is hereby incorporated by reference.

### FIELD OF THE INVENTION

Example embodiments of the present invention include an apparatus, method, system, and computer program and product, each capable of controlling network communications.

### BACKGROUND

In a network system based on a server-client model, a server apparatus sends a response to a request received from a client apparatus through a network. For example, the client may send the request in the form of uniform resource locator (URL), which indicates the location of a desired resource on the network. The URL mainly includes a scheme name defining the type of the desired resource, a host name identifying a server apparatus providing the desired resource, and a path name specifying the location of a html document in the server apparatus. The scheme name of the URL may be generally referred to as a communication protocol such as Hypertext Transfer Protocol (HTTP) or file transfer protocol (FTP), as the scheme name is designed to be used with a specific protocol.

In order to securely exchange data over the network, various techniques of controlling network communications have been applied, for example, as described in the Japanese Patent Application Publication No. 2001-298449, or the Japanese Application Patent No. 3796496. In another example, the server apparatus may change the host name of the URL, which may be provided by the client apparatus, to the host name of another server apparatus.

Alternatively, in order to securely exchange data over the network, the server apparatus may change the scheme name of the URL, or the communication protocol, which may be provided by the client apparatus. For example, the server apparatus may automatically switch the communication protocol from HTTP to Hypertext Transfer Protocol over Secure Socket Layer (HTTPS).

Referring to FIG. 1, operation of switching the communication protocol from HTTP to HTTPS is explained. In this example, a client apparatus 50 sends a request to a server apparatus 60 via a network. The server apparatus 60 includes a plurality of modules such as httpd 61, libhttp 62, libgwww 63, libacacia 64, web page function (WPF) 65, and URL generator 66. The server apparatus 60 further includes a security settings table 67.

Still referring to FIG. 1, when a web browser of the client apparatus 50 receives a request “http://serverIP/test.cgi” from a user, the web browser obtains an IP address corresponding to the host name “serverIP” from a DNS sever, and sends the request “http://133.139.49.214/test.cgi” using HTTP method such as GET method to the server apparatus 60. The request received by the httpd 61 is sent to the URL generator 66 through the libhttp 62, libgwww 63, libacacia 64, and WPF 65.

The URL generator 66 refers to the security settings table 67 to generate an URL using HTTPS. The URL being generated is sent to the web browser of the client apparatus 50 with the 302 error code. The client apparatus 50 sends a request to the server apparatus 60 with the URL being received from the server apparatus 60. When the request is received from the client apparatus 50 through the httpd 61, libhttp 62, libgwww 63, and libacacia 64, the WPF 65 of the server apparatus 60 generates a html document according to the request, and sends the html document to the client apparatus 50 via the network. The web browser of the client apparatus 50 analyzes the html document, and displays the contents of the html document to the user.

Recently, the server apparatus may be provided with a plurality of IP addresses each providing a different level of security. In such case, if the client apparatus specifies the server apparatus by its host name as described above referring to FIG. 1, the IP address of the server apparatus being obtained by the DNS server may not be the IP address that satisfies a desired security level of network communications.

Alternatively, the client apparatus may access the server apparatus with the IP address, which may be used for the previous communication. However, the IP address previously used may not be the IP address that satisfies the desired security level of network communications.

Even when the IP address previously used satisfies the desired security level, there is no guarantee that such IP address will be used every time the client apparatus communicates with the server apparatus.

Further, the security level of network communications may be affected by various other factors. For example, the IP security (IPsec), which is a suite of protocols for securing network communications, may improve the security level of network communications when implemented.

The server apparatus may refuse to communicate with the client apparatus when the client apparatus accesses the server apparatus with the IP address providing the security level lower than the desired security level or when the client apparatus accesses the server apparatus using a connection method not desired. In such case, the user may need to search for an IP address or a connection method that satisfies the desired security level. This may decrease the usability of the network system.

### SUMMARY

In view of the above-described and other limitations, example embodiments of the present invention provide a technique of establishing communication between a server apparatus and a client apparatus in a manner that satisfies a desired security level of network communications.

Example embodiments of the present invention include a communication apparatus coupled to a counterpart apparatus via a network. The communication apparatus includes a network interface and a network controller. The network interface receives a request generated by the counterpart apparatus, which includes address information regarding an address currently used for communication between the communication apparatus and the counterpart apparatus. The network controller determines whether the address information obtainable from the request satisfies a desired security level specified by settings information to generate a determination result, obtain a desired address that satisfies the desired security level when the determination result indicates that the address information does not satisfy the desired security level, and send a response including address information regarding the desired address being obtained to the counterpart apparatus

Example embodiments of the present invention include a communication control method of controlling communication between a communication apparatus and a counterpart apparatus, which may be performed by the communication apparatus. The communication control method includes: receiving a request generated by the counterpart apparatus, the request including address information regarding an address currently used for communication between the communication apparatus and the counterpart apparatus; determining whether the address information obtainable from the request satisfies a desired security level specified by settings information to generate a determination result; obtaining a desired address that satisfies the desired security level when the determination result indicates that the address information does not satisfy the desired security level; and sending a response to the counterpart apparatus, the response including address information regarding the desired address being obtained.

Example embodiments of the present invention include a communication system including a server apparatus and a client apparatus that are communicable via a network. The client apparatus generates a request including address information regarding an address currently used for communication with the server apparatus. When the request is received, the server apparatus determines whether the address information obtainable from the request satisfies a desired security level specified by settings information to generate a determination result. The server apparatus obtains a desired address that satisfies the desired security level when the determination result indicates that the address information does not satisfy the desired security level, and sends a response to the client apparatus, which includes address information regarding the desired address being obtained. When the response is received, the client apparatus sends a request including the address information regarding the desired address.

The above-described communication system may additionally include a DNS server, which may be coupled to the server apparatus via the network. The DNS server may send one or more client addresses to the server apparatus. The server apparatus may select a desired client address from the one or more client addresses obtained from the DNS server, and use the selected address as the desired address.

Example embodiments of the present invention include a computer readable recording medium including computer program instructions which cause a communication apparatus to execute a communication control method of controlling communication between the communication apparatus and a counterpart apparatus. The communication control method includes: receiving a request generated by the counterpart apparatus, the request including address information regarding an address currently used for communication between the communication apparatus and the counterpart apparatus; determining whether the address information obtainable from the request satisfies a desired security level specified by settings information to generate a determination result; obtaining a desired address that satisfies the desired security level when the determination result indicates that the address information does not satisfy the desired security level; and sending a response to the counterpart apparatus, the response including address information regarding the desired address being obtained.

In addition to the above-described example embodiments, the present invention may be practiced in various other ways.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a data flow diagram illustrating operation of changing a communication protocol from HTTP to HTTPS;

FIG. 2 is a schematic block diagram illustrating the configuration of a network system including a server apparatus and a client apparatus, according to an example embodiment of the present invention;

FIG. 3 is a schematic block diagram illustrating the software structure of a selected portion of the server apparatus shown in FIG. 2, according to an example embodiment of the present invention;

FIG. 4 is a schematic block diagram illustrating the software structure of a selected portion of the server apparatus shown in FIG. 2, according to an example embodiment of the present invention;

FIG. 5 is a security settings table stored in the server apparatus shown in FIG. 4 according to an example embodiment of the present invention;

FIG. 6 is a secure address settings table stored in the server apparatus shown in FIG. 4 according to an example embodiment of the present invention;

FIG. 7 is a local address table stored in the server apparatus shown in FIG. 4 according to an example embodiment of the present invention;

FIG. 8 is an illustration of a header portion of a request, received by the server apparatus shown in FIG. 4, according to an example embodiment of the present invention;

FIG. 9 is a data flow diagram illustrating operation of obtaining a desired IP address that satisfies a desired security level, according to an example embodiment of the present invention;

FIGS. 10A and 10B are a flowchart illustrating operation of obtaining a desired IP address that satisfies a desired security level, performed by the server apparatus of FIG. 4, according to an example embodiment of the present invention;

FIG. 11 is a search table generated by the server apparatus of FIG. 4, according to an example embodiment of the present invention;

FIG. 12 is a flowchart illustrating operation of obtaining a desired IP address having a version specified by settings information, according to an example embodiment of the present invention;

FIGS. 13A and 13B are a flowchart illustrating operation of determining whether the use of IPsec communication is required or preferred, according to an example embodiment of the present invention;

FIG. 14 is a search result table generated by the server apparatus of FIG. 4, according to an example embodiment of the present invention;

FIG. 15 is a flowchart illustrating operation of obtaining a desired IP address that communicates using a connection method specified by settings information, according to an example embodiment of the present invention;

FIG. 16 is a schematic diagram illustrating the software structure of a server apparatus shown in FIG. 2, according to an example embodiment of the present invention;

FIG. 17 is a data flow diagram illustrating operation of obtaining a desired IP address that satisfies a desired security level, according to an example embodiment of the present invention;

FIG. 18 is an illustration for explaining security policy information stored in the server apparatus shown in FIG. 16, according to an example embodiment of the present invention;

FIG. 19 is an illustration for explaining log data stored in the server apparatus shown in FIG. 16, according to an example embodiment of the present invention;

FIG. 20 is a warning table stored in the server apparatus shown in FIG. 16, according to an example embodiment of the present invention;

FIG. 21 is a flowchart illustrating operation of obtaining a desired IP address, according to an example embodiment of the present invention;

FIG. 22 is a flowchart illustrating operation of obtaining a desired IP address, according to an example embodiment of the present invention;

FIG. 23 is a flowchart illustrating operation of obtaining a desired IP address, according to an example embodiment of the present invention;

FIG. 24 is a flowchart illustrating operation of selecting a desired IP address, according to an example embodiment of the present invention;

FIG. 25 is a flowchart illustrating operation of obtaining a security policy priority order, according to an example embodiment of the present invention;

FIG. 26 is a flowchart illustrating operation of determining whether selection of desired IP address is subjected to warning, according to an example embodiment of the present invention;

FIG. 27 is a flowchart illustrating operation of determining whether selection of desired IP address is subjected to warning, according to an example embodiment of the present invention;

FIG. 28 is a schematic diagram illustrating a software structure of a server apparatus according to an example embodiment of the present invention;

FIG. 29 is a data flow diagram illustrating operation of obtaining a desired IP address that satisfies a desired security level, according to an example embodiment of the present invention; and

FIG. 30 is a schematic diagram illustrating the hardware structure of the server apparatus shown in FIG. 2, according to an example embodiment of the present invention.

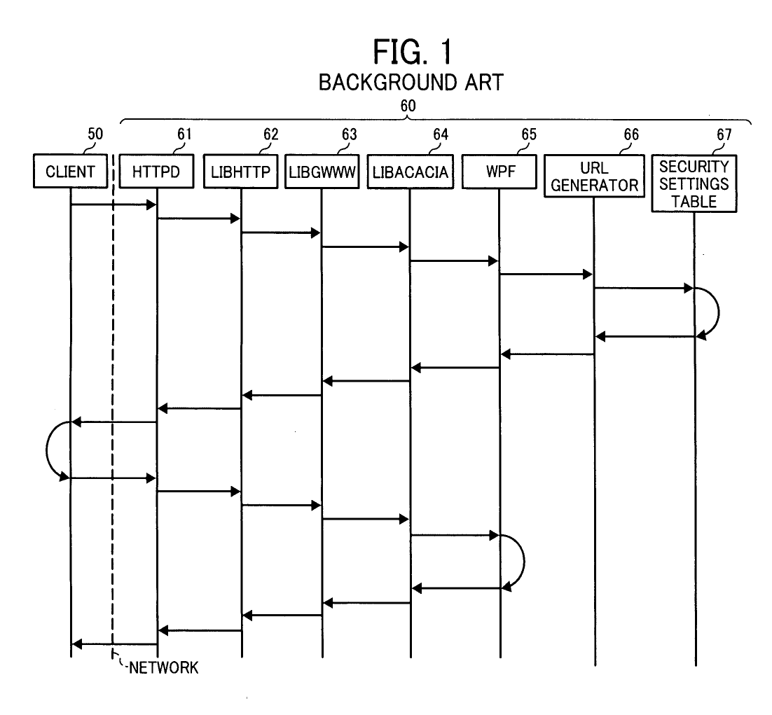

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

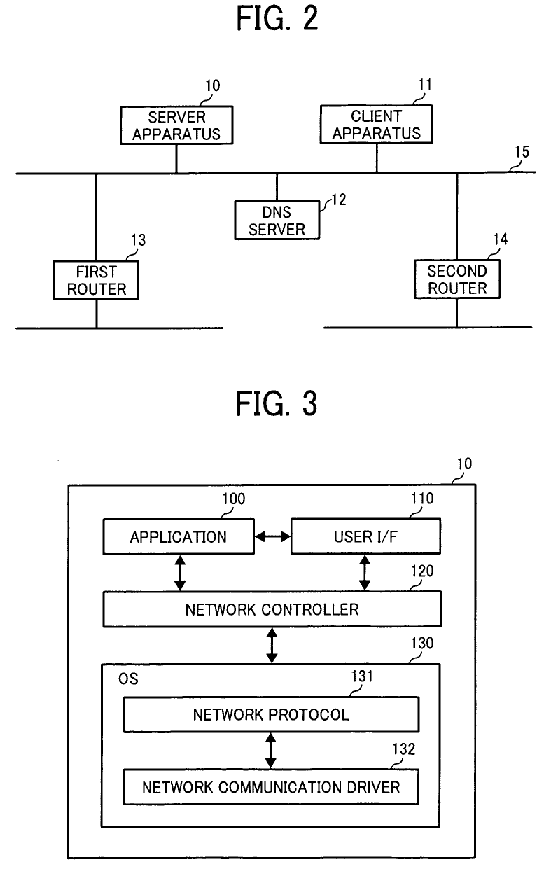

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner. Referring now to the drawings, wherein like reference numerals designate identical or corresponding parts throughout the several views, FIG. 2 illustrates a network system according to an example embodiment of the present invention.

The network system of FIG. 2 includes a server apparatus 10, a client apparatus 11, and a domain name system (DNS) server 12, which are all connected to a network 15 on which a first router 13 and a second router 14 are provided. The server apparatus 10 and the client apparatus 11 each have an internet protocol (IP) address having prefix information provided by the first router 13, and an IP address having prefix information provided by the second router 14.

For example, when the first router 13 provides the prefix information, which may be expressed as “2001:1:2:3::/64”, respectively to the server apparatus 10 and the client apparatus 11, the server apparatus 10 and the client apparatus 11 may be respectively assigned with the IP address of “2001:1:2:3::2” and the IP address of “2001:1:2:3::3”. When the second router 14 provides the prefix information, which may be expressed as “2001:1:2:5::/64”, respectively to the server apparatus 10 and the client apparatus 11, the server apparatus 10 and the client apparatus 11 may be respectively assigned with the IP address of “2001:1:2:5::2” and the IP address of “2001:1:2:5::3”. The DNS server 12 stores one or more IP addresses for each one of the server apparatus 10 and the client apparatus 11. In the example case described above, the DNS server 12 may store the IP address “2001:1:2:3::2” and the IP address “2001:1:2:5::2” as the registered address of the server apparatus 10. The DNS server 12 may store the IP address “2001:1:2:3::3” and the IP address “2001:1:2:5::3” as the registered address of the client apparatus 11.

Alternatively, the server apparatus 10 and the client apparatus 11 may be each provided with more than two IP addresses depending on the configuration of the network system and/or the apparatus. In another example, any one of the server apparatus 10 and the client apparatus 11 may be provided with more than one network interfaces, each of which may be assigned with a specific IP address.

Further, in this example, the server apparatus 10 may store settings information, which may be previously set by default or according to the user preference. In one example, the settings information may include information regarding an address to be used for communication between the server apparatus 10 and the client apparatus 11, such as a version of an IP address to be used for the server apparatus 10 or the client apparatus 11. In another example, the settings information may include information regarding a connection method to be used between the server apparatus 10 and the client apparatus 11, such as whether the use of IPsec communication is preferred or required. In another example, the settings information may include information indicating whether changing of an address or a connection method, each of which may be used for communication between the server apparatus 10 and the client apparatus 11, is allowed or prohibited. As described below, the settings information may be used to manage the security level of network communications such that the server apparatus 10 and the client apparatus 11 communicate with each other while satisfying the desired security level.

In one example, when the server apparatus 10 receives a request from the client apparatus 11, the server apparatus 10 determines whether an address obtainable from the request satisfies the desired security level specified by the settings information stored in the server apparatus 10. In this example, the address obtainable from the request may correspond to an address to be used for communication between the server apparatus 10 and the client apparatus 11, such as an IP address of the server apparatus 10 (“the server IP address”), and/or an IP address of the client apparatus 11 (“the client IP address”). When it is determined that the address obtainable from the request does not satisfy the desired security level, the server apparatus 10 may search for a desired address, such as a desired server IP address and/or a desired client IP address, that satisfies the desired security level. In one examples the server apparatus 10 may search through a plurality of addresses stored in the server apparatus 10. In another example, the server apparatus 10 may request the DNS server 12 to perform name resolution to obtain one or more addresses, and return the obtained addresses to the server apparatus 10. When the desired address that satisfies the desired security level is found, the server apparatus 10 generates an URL specifying the desired address being obtained, and sends a response including the URL to the client apparatus 11. The client apparatus 11 may automatically send a request with the URL obtained from the server apparatus 10. The desired address being obtained may be stored in any one of the server apparatus 10 and the client apparatus 11 for later use. The above-described operation of changing the address or connection method may be performed, for example, when the settings information indicates that changing of the address or connection method is allowed.

In another example, when the server apparatus 10 receives a request from the client apparatus 11, the server apparatus 10 determines whether an address obtainable from the request satisfies the desired security level specified by the settings information stored in the server apparatus 10. When it is determined that the address obtainable from the request does not satisfy the desired security level, the server apparatus 10 may send a response with the error code to the client apparatus 11, such as the 404 error code which indicates that the requested page is not found. The above-described operation of prohibiting access from the client apparatus 11 may be performed, for example, when the settings information indicates that changing of the address or connection method is prohibited.

In order to perform one or more functions described above or below, the server apparatus 10 may have a software structure, which includes an application 100, user interface (I/F) 110, network controller 120, and operation system (OS) 130 including a network protocol 131 and a network communication driver 132, for example, as illustrated in FIG. 3.

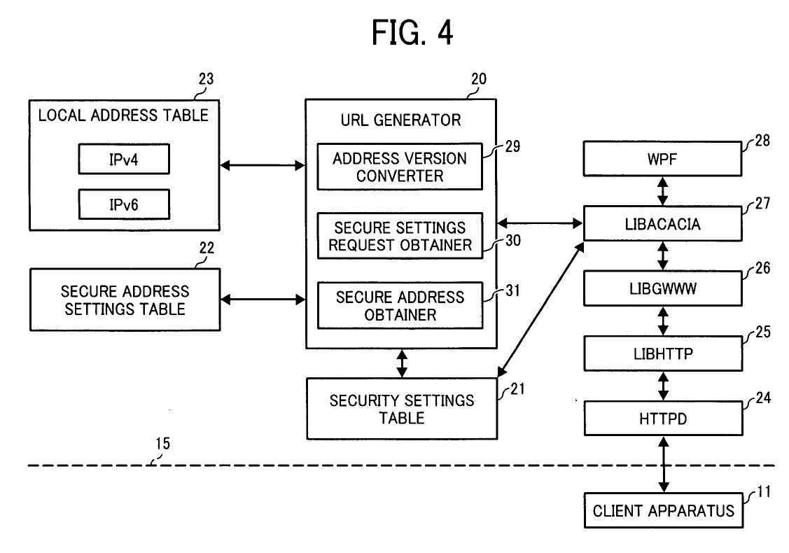

Referring now to FIGS. 4 to 15, operation of obtaining a desired IP address that satisfies the desired security level specified by the settings information is explained, according to an example embodiment of the present invention.

FIG. 4 illustrates a software structure of a selected portion of the server apparatus 10 according to an example embodiment of the present invention. The software structure shown in FIG. 4 may correspond to the application 100 and the network controller 120 of FIG. 3. For example, the application 100 may include the plurality of modules 20, 24, 25, 26, 27, and 28. The network controller 120 may include a storage to store the settings information, such as a storage to store a security settings table 21, secure address settings table 22, and local address table 23.

The server apparatus 10 of FIG. 4 includes an URL generator 20, a security settings table 21, a local address table 23, a secure address settings table 22, and a plurality of modules including httpd 24, libhttp 25, libgwww 26, libacacia 27, and WPF 28.

The URL generator 20 of the server apparatus 10 determines whether an IP address obtainable from the request generated by the client apparatus 11 satisfies the desired security level specified by the settings information, which may be obtainable, for example, from the security settings table 21. When it is determined that the IP address obtained from the request does not satisfy the desired security level, the URL generator 20 searches for a desired IP address that satisfies the desired security level, for example, using information obtainable from any one of the local address table 23, secure address settings table 22, and DNS server 12. When the desired IP address is obtained, the URL generator 20 generates an URL including information regarding the desired IP address, and sends a response that requests the client apparatus 11 to send a request using the URL including information regarding the desired IP address being obtained. In this example, the URL generator 20 includes an address version converter 29, a secure settings request obtainer 30, and a secure address obtainer 31.

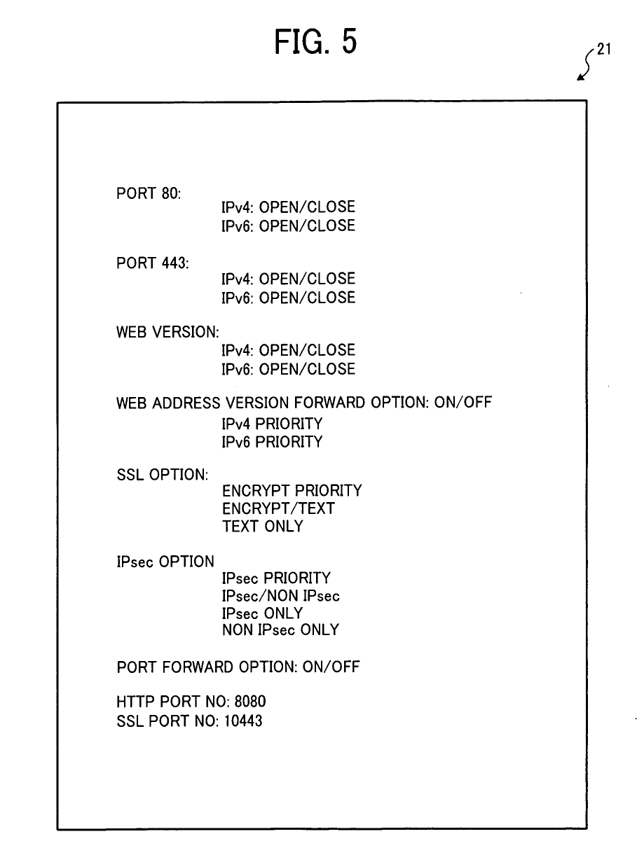

The security settings table 21 stores settings information, such as various parameters specifying the security level of communication between the server apparatus 10 and the client apparatus 11. As illustrated in FIG. 5, examples of the settings information may include, but not limited to, information indicating whether the port 80 assigned to the WWW is open or closed (“Port 80”), information indicating whether the port 443 assigned to the secure WWW is open or closed (“Port 443”), information indicating the version of the IP address to be used for communication (“Web version”), information indicating whether the forward option is available to switch the currently-used IP address to the IP address having the version specified by the “Web version” (“Web address version forward option”), information regarding the settings of secure socket layer (“SSL option”), information regarding the settings of IPsec communication (“IPsec option”), information indicating whether the forward option is available to switch the port (“Port forward option”), the port number assigned to the HTTP port (“HTTP Port No.”), and the port number assigned to the SSL port (“SSL Port No.”). The security settings table 21 may be previously set by default. Alternatively, the security settings table 21 may be set by the user, for example, through the user I/F 110 (FIG. 3).

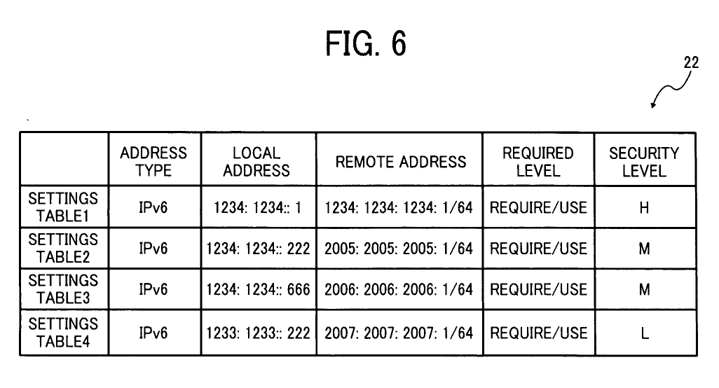

The secure address settings table 22 stores information regarding the settings of secure communication using IPsec. As illustrated in FIG. 6, the secure address settings table 22 may include information regarding the version of IP address to be used (“ADDRESS TYPE”), the IP address of the server apparatus 10 (“LOCAL ADDRESS”), the IP address of a counterpart apparatus of the server apparatus 10 such as the client apparatus 11 (“REMOTE ADDRESS”), the required level indicating whether the use of IPsec communication is required or preferred (“REQUIRED LEVEL”), and the IPsec security level indicating the communication security level required for the IPsec communication (“SECURITY LEVEL”). Further, still referring to FIG. 6, the above-described information items may be stored with respect to the corresponding one of the security settings tables 1 to 4.

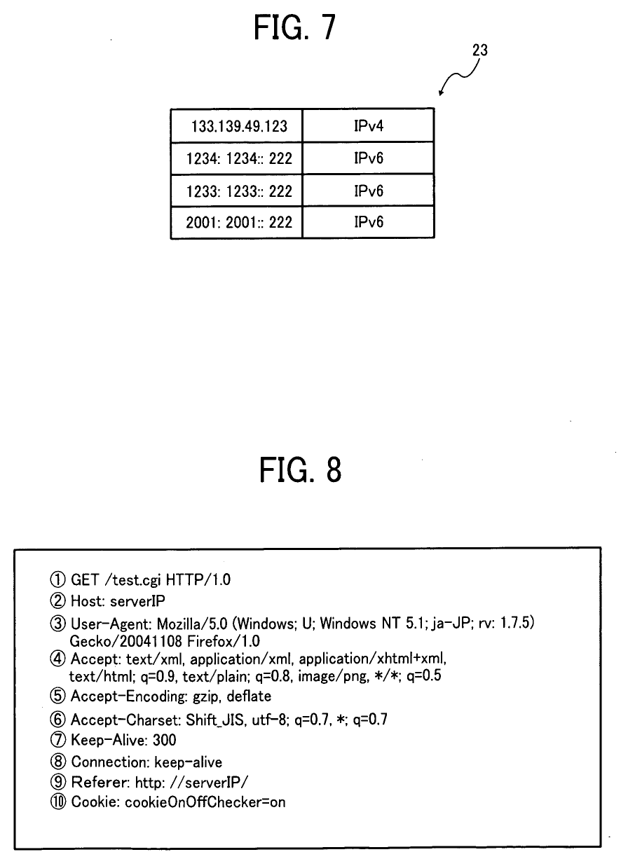

The local address table 23 stores information regarding one or more server IP addresses available for use by the server apparatus 10. In this example, as illustrated in FIG. 7, the local address table 23 may store one IP address having the version number of 4, and three IP addresses each having the version number of 6.

The server apparatus 10 of FIG. 4 may be implemented in various other ways. For example, the structure of the URL generator 20 may be changed depending on a type of the desired address required by the server apparatus 10.

In example operation, when a request is received from the client apparatus 11, the httpd 24 of the server apparatus 10 receives the request, and sends the request to the URL generator 20 through the libhttp 25, libgwww 26, and libacacia 27. In response to the request, the WPF 28 may generate a html document according to the request sent from the client apparatus 11, and sends the html document to the client apparatus 11 through the libacacia 27, libgwww 26, libhttp 25, and httpd 24.

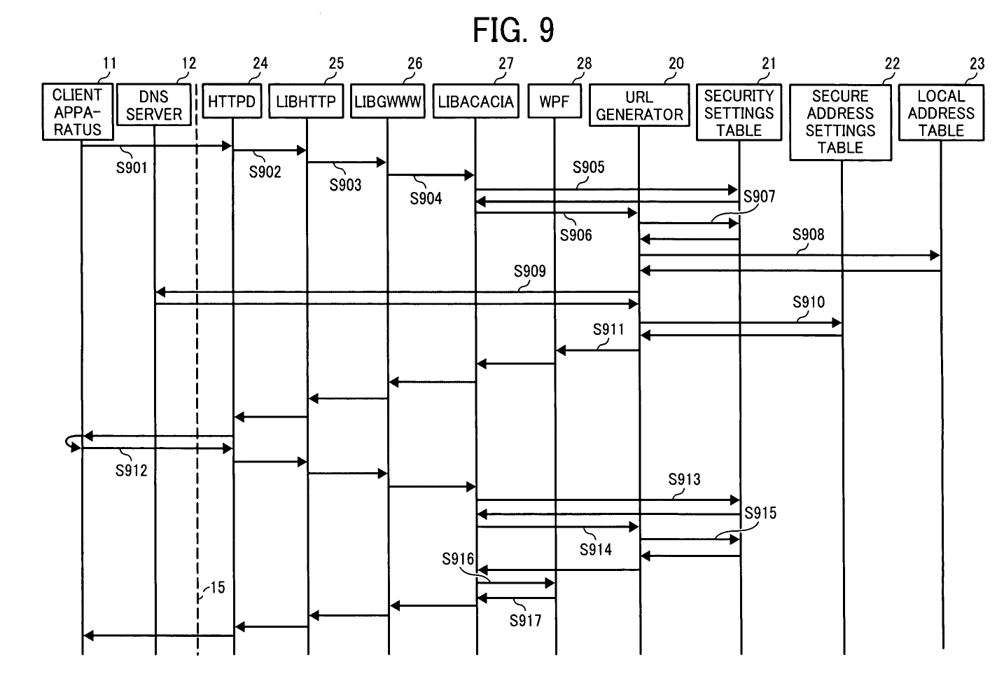

Referring to FIG. 9, operation of obtaining a desired IP address that satisfies the desired security level, performed by the network system of FIG. 2, is explained according to an example embodiment of the present invention.

At S901, a web browser of the client apparatus 11 is requested by the user through the user I/F 110 (FIG. 3) to send a request “http://serverIP/test.cgi” to the server apparatus 10. The DNS server 12 obtains an IP address corresponding to the host name “serverIP”. In this example, the DNS server 12 is assumed to obtain the IP address “133.139.49.123”. The httpd 24 of the client apparatus 10 receives the request “http://133.139.49.123/test.cgi”, and requests the libhttp 25 to analyze the request.

At S902, the libhttp 25 analyzes the contents of the request. For example, from the header portion of the request shown in FIG. 8, various information may be obtained including, for example, identification of the client apparatus 11 such as the host name of the client apparatus 11, identification of the server apparatus 10 such as the host name “serverIP” of the server apparatus 10, the application name, the data encryption algorithm, the specified character code, and the time when access is made by the client apparatus 11.

Based on the analysis made by the libhttp 25, at S903, the libgwww 26 sends the request to a module capable of processing the request, such as the libacacia 27.

At S904, the libacacia 27 may apply common processing such as log-in management or data conversion. Further, in this example, at S905, the libacacia 27 may refer to security settings information stored in the security settings table 21 to determine whether the security level needs to be managed for the server apparatus 10. When the security settings information indicates that security management is necessary, at S906, the libacacia 27 requests the URL generator 20 to determine whether the IP address being obtained from the request satisfies the desired security level specified by the settings information stored in the security settings table 21. In this example, at S906, the libacacia 27 may request the URL generator 20 to generate a URL including the desired address that satisfies the desired security level.

At S907, the URL generator 20 refers to the security settings table 21 to determine the security level specified by the security settings information. At S908, the URL generator 20 may obtain, from the local address table 23, a plurality of server IP addresses available for use by the server apparatus 10. The URL generator 20 determines whether any one of the plurality of server IP addresses being obtained satisfies the desired security level specified by the security settings information. Based on the determination result, the URL generator 20 may select one or more server IP addresses each satisfying the desired security level.

Further, at S909, the URL generator 20 may request the DNS server 12 to obtain a plurality of client IP addresses each corresponding to the client apparatus 11.

At S910, the URL generator 20 may obtain the desired IP address to be assigned to the server apparatus 10 and the desired IP address to be assigned to the client apparatus 11, for example, by using the information stored in the secure address settings table 22.

At S911, the URL generator 20 generates a URL including the desired IP addresses of the server apparatus 10 and the client apparatus 11, and sends the URL with the 302 error code. At S912, the client apparatus 11 sends a request using the URL being obtained from the server apparatus 10 to the server apparatus 10. For example, when the desired IP address of 1234.1234.222 is obtained for the server apparatus 10, the client apparatus 11 accesses the server apparatus 10 with the IP address of 1234.1234.222.

The request received by the httpd 24 is sent to the libacacia 27 in a substantially similar manner as described above referring to S902, S903, and S904. Further, at S913, the libacacia 27 may determine whether security management is necessary in a substantially similar manner as described above referring to S905. When it is determined that security management is necessary, at S914, the libacacia 27 requests the URL generator 20 to check for the IP address being obtained from the request in a substantially similar manner as described above referring to S906. At S915, the URL generator 20 determines whether the IP address obtained from the request satisfies the desired security level by referring to the security settings information stored in the security settings table 21 in a substantially similar manner as described above referring to S907. When it is determined that the IP address obtained from the request satisfies the desired security level, at S916, the libacacia 27 requests the WPF 28 to generate a html document according to the request. At S917, the html document is sent from the WPF 28 to the client apparatus 11 through the libacacia 27, libgwww 26, libhttp 25, and httpd 24.

As described above, the server apparatus 10 sends a resource requested by the client apparatus 11 only when the security level of communication between the server apparatus 10 and the client apparatus 11 satisfies the desired security level previously set. Further, when it is determined that the means for communication, such as the address or connection method, needs to be changed to satisfy the desired security level, the server apparatus 10 may automatically change the means for communication, for example, by obtaining a desired address to be used for communication, without the need for human intervention.

The operation of FIG. 9 may be performed in various other ways. For example, when the URL generator 20 determines that the IP address obtained from the request does not satisfy the desired security level at S907, the URL generator 20 may return the 404 error code to the client apparatus 11 without searching any desired IP address. In this example, whether to perform operation of obtaining a desired address may be determined based on the security settings information stored in the security settings table 21. For example, referring to FIG. 5, when the “web address version forward option” indicates that the forward option is not selected, the desired address is not obtained even when the address obtained from the request is not the address specified by the security settings information.

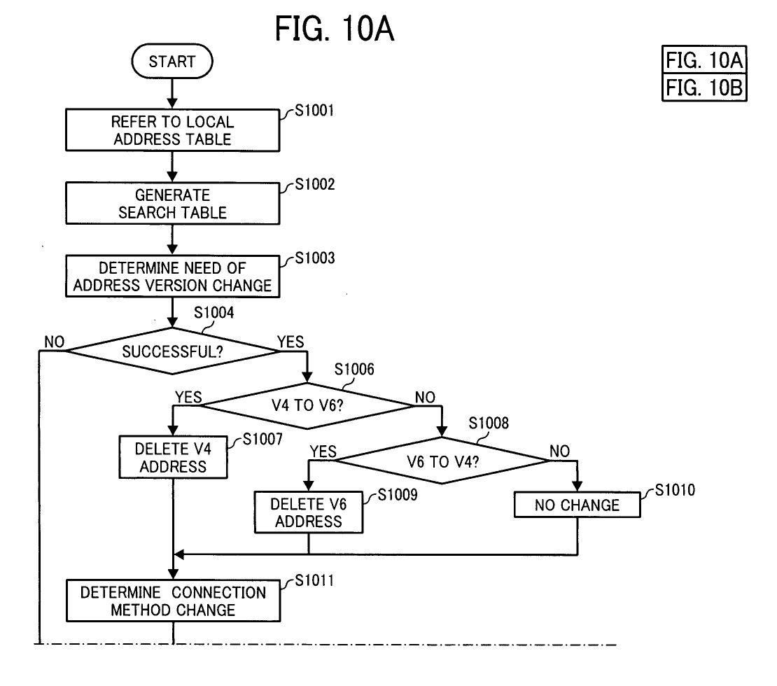

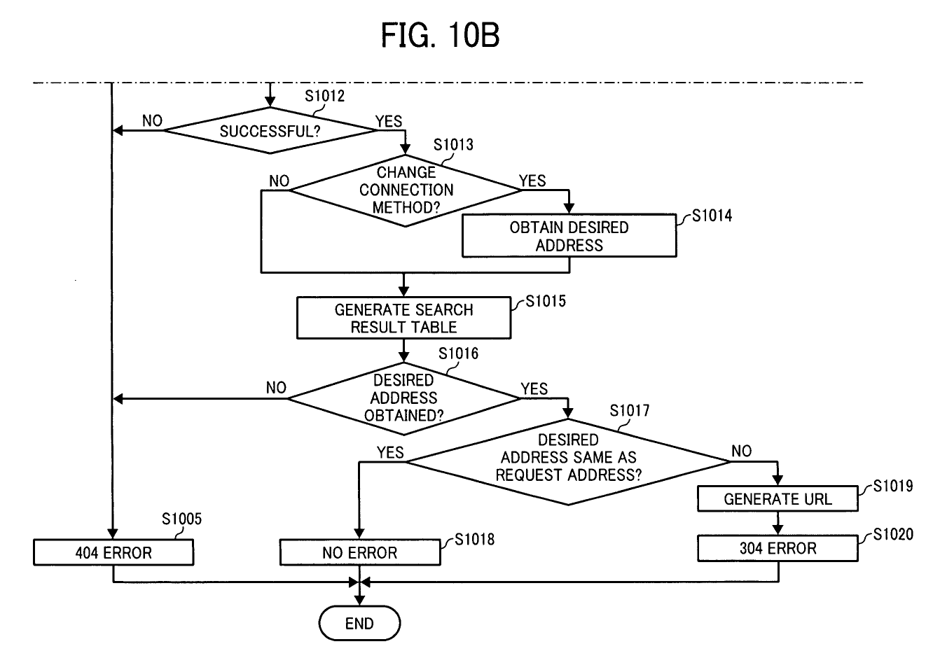

Referring now to FIGS. 10A and 10B, operation of obtaining a desired IP address that satisfies the desired security level, performed by the server apparatus 10 of FIG. 4, is explained according to an example embodiment of the present invention. The operation of FIGS. 10A and 10B may be performed by the URL generator 20 when a request for generating an URL is received from the libacacia 27 as described above referring to S906 of FIG. 9.

S1001 refers to the local address table 23, for example, the local address table 23 shown in FIG. 7, to obtain a plurality of server IP addresses available for use by the server apparatus 10.

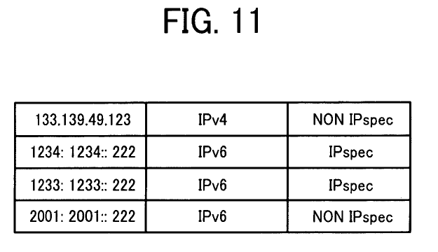

S1002 generates a search table using information stored in the local address table 23 and information stored in the secure address settings table 22. In this example, the search table may be generated for temporary use by the URL generator 20 for the purpose of obtaining the desired server IP address and/or the desired client IP address. For example, the URL generator 20 may generate a search table illustrated in FIG. 11 by copying information stored in the local address table 23 of FIG. 7, and adding information indicating whether IPsec communication is required for each of the plurality of server IP addresses. Information indicating whether IPsec communication is required may be obtained from the secure address settings table 22 of FIG. 6, by referring to the “required level” information for each one of the plurality of “local addresses”. For example, when the “required level” information indicates that IPsec communication is necessary or preferred, it is assumed that IPsec communication is required or preferred (“IPsec” in FIG. 11). When the “required level” information indicates that IPsec communication is not preferred or necessary, it is assumed that IPsec communication is not preferred or necessary (“non-IPsec” in FIG. 11).

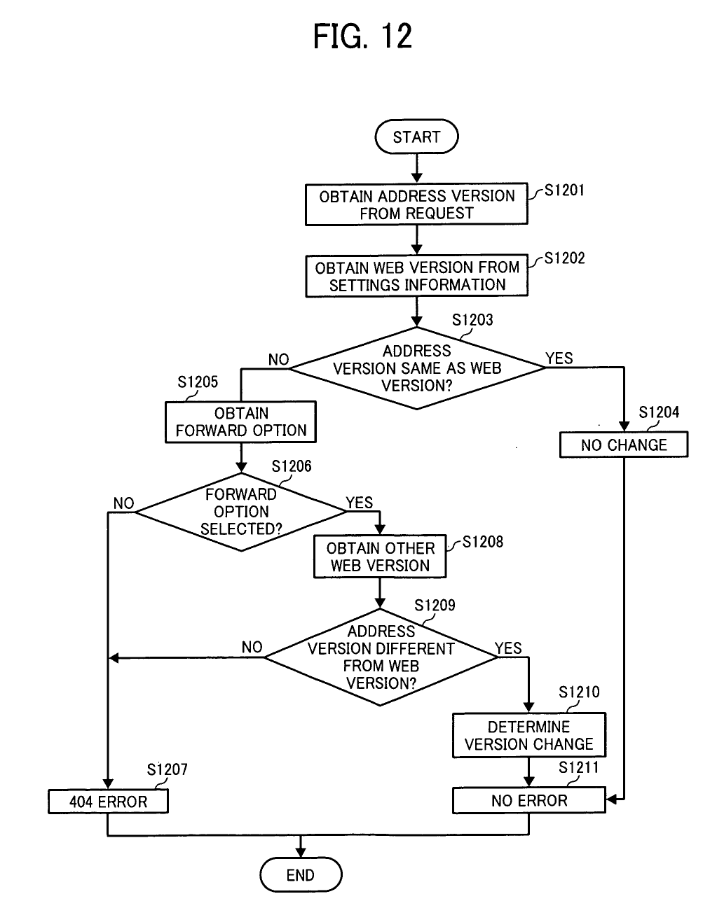

Referring back to FIG. 10A, S1003 determines whether to change the address version of the server IP address obtained from the request. For example, the address version converter 29 of FIG. 4 may perform operation of FIG. 12, which is described below. The operation of FIG. 12 may be performed, for example, when the settings information indicates that the use of IP address version capable of providing a predetermined security level is required. For the descriptive purpose, as illustrated in FIG. 12, it is assumed that either one of the version 4 and version 6 is required or preferred for the IP address. S1004 determines whether S1003 of determining is successfully performed. When it is determined that S1003 of determining is not successful (“NO” at S1004), the operation proceeds to S1005 to return the “404 Not Found error” code to the client apparatus 11. When it is determined that S1003 of determining is successful (“YES” at S1004), the operation proceeds to S1006.

S1006 determines whether the determination result of S1003 indicates that the address version needs to be changed from the version 4 to the version 6. When it is determined that the address version needs to be changed from the version 4 to the version 6 at S1006 (“YES” at S1006), the operation proceeds to S1007. At S1007, information regarding the IP address having the version number of 4 is deleted from the search table, thus leaving only information regarding the IP address having the version number of 6.

When it is determined that the address version does not need to be changed from the version 4 to the version 6 at S1006 (“NO” at S1006), the operation proceeds to S1008. S1008 determines whether the determination result of S1003 indicates that the address version needs to be changed from the version 6 to the version 4. When it is determined that the address version needs to be changed from the version 6 to the version 4 at S1008 (“YES” at S1008), the operation proceeds to S1009. At S1009, information regarding the IP address having the version number of 6 is deleted from the search table, thus leaving only information regarding the IP address having the version number of 4. When it is determined that the address version does not need to be changed from the version 6 to the version 4 at S1008 (“NO” at S1008), the operation proceeds to S1010 to determine that no change is required.

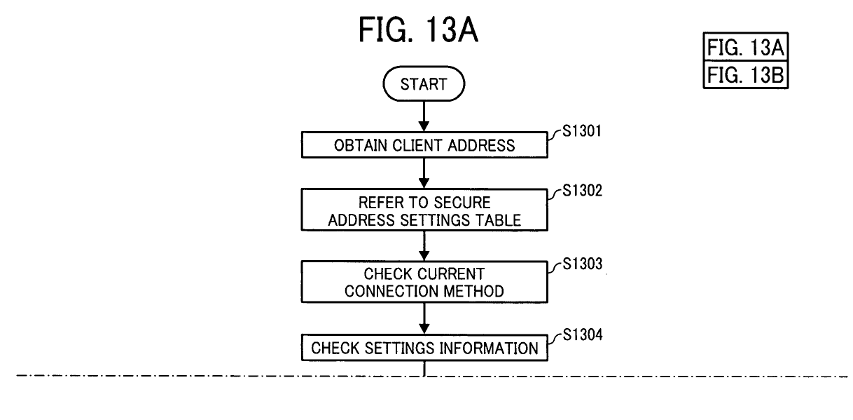

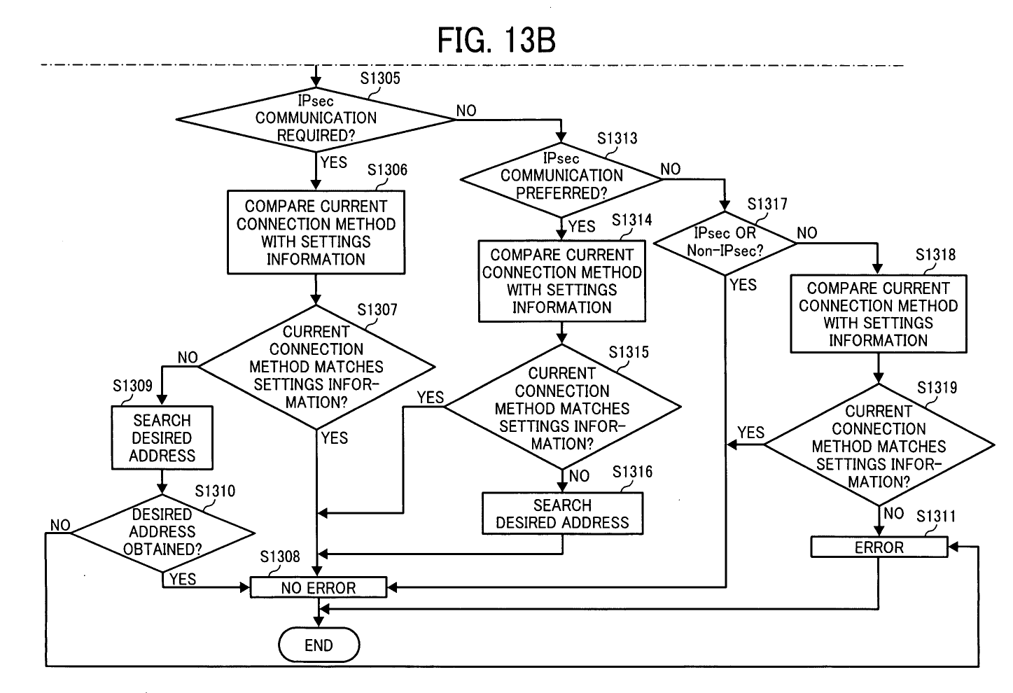

S1011 determines whether the connection method currently used between the server apparatus 10 and the client apparatus 11 needs to be changed. For example, whether the use of IPsec communication is required or preferred may be determined. For example, the secure settings request obtainer 30 of FIG. 4 may perform operation of FIGS. 13A and 13B, which is described below. The operation of FIGS. 13A and 13B may be performed, for example, when the security settings information requires the use of IPsec communication for improved security.

Referring to FIG. 10B, S1012 determines whether S1011 of determining is successfully performed. When it is determined that S1011 of determining is not successful (“NO” at S1012), the operation proceeds to S1005 to return the “404 Not Found error” code to the client apparatus 11. When it is determined that S1011 of determining is successful (“YES” at S1012), the operation proceeds to S1013.

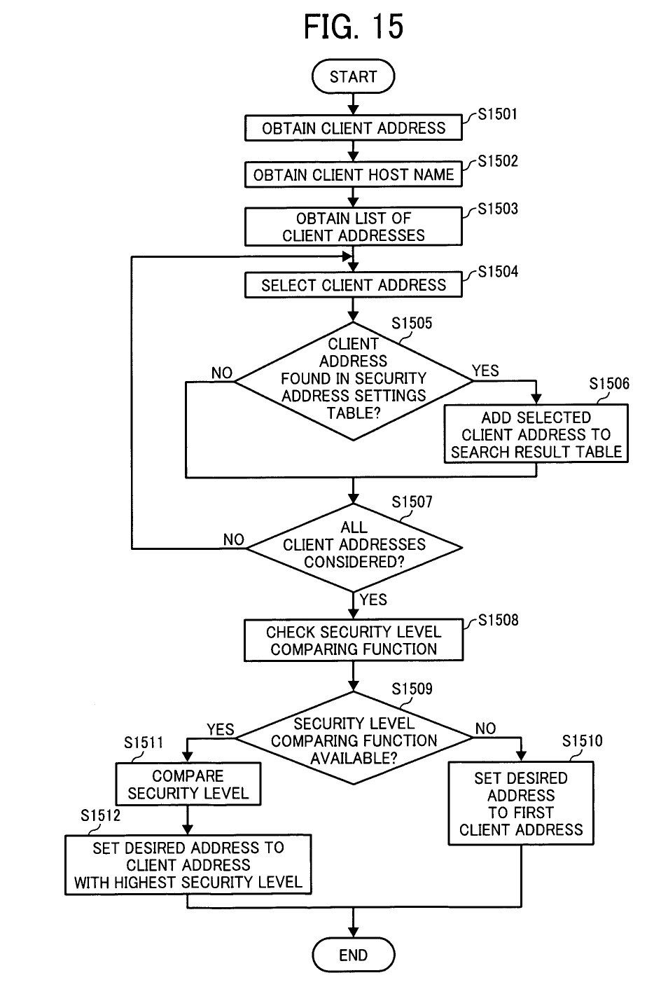

S1013 determines whether the determination result of S1011 indicates that the connection method needs to be changed according to the settings information. When it is determined that the connection method needs to be changed at S1013 (“YES” at S1013), the operation proceeds to S1014 to obtain a desired IP address that uses the connection method satisfying the settings information. For example, the secure address obtainer 31 of FIG. 4 may perform operation of FIG. 15, which is descried below, to obtain an IP address using IPsec communication for each one of the server apparatus 10 and the client apparatus 11 to implement IPsec communication.

When it is determined that the connection method does not need to be changed at S1013 (“NO” at S1013), the operation proceeds to S1015.

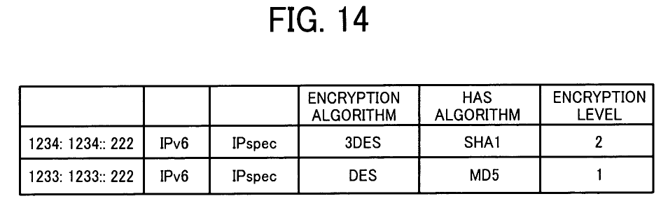

S1015 generates a search result table, which includes one or more IP addresses obtained as a desired IP address. For example, the search result table shown in FIG. 14 may be generated. The search result table of FIG. 14 lists a plurality of server IP addresses that satisfies the desired security level specified by the settings information, which may be selected from the search table of FIG. 11. In this example, the security settings information 21 indicates that the IP address having the version number 4 and using IPsec communication is required. As a result, two server IP addresses “1234:1234::222” and “1233:1233::222” shown in FIG. 14 are selected, each having the version number 4 and using IPsec communication.

The search result table of FIG. 14 further includes information regarding the IPsec communication security level, such as information regarding encryption algorithm, authentication algorithm such as hash algorithm, and encryption level. The information regarding the IPsec communication security level of FIG. 14 may be determined based on the IPsec security level information (“SECURITY LEVEL”) stored in the secure address settings table 22 of FIG. 6. Such information regarding the IPsec communication security level may be used to select a desired IP address from the search result table when the search result table includes more than one IP address. For example, the IP address having the highest IPsec communication security level may be selected as a desired IP address for improved security. In this example case shown in FIG. 14, the IP address “1234:1234::222” may be selected as it has the security level higher than the security level of the IP address “1233:1233::222”. Alternatively, as described below, selection of the desired IP address may be performed in various other ways.

S1016 determines whether any desired IP address is obtained that satisfies the security level specified by the security settings information. When it is determined that no desired IP address is obtained at S1016 (“NO” at S1016), the operation proceeds to S1005 to return the “404 Not Found error” to the client apparatus 11. When it is determined that the desired IP address is obtained at S1016 (“YES” at S1016), the operation proceeds to S1017.

S1017 determines whether the desired IP address is the same as the IP address obtained from the request. When it is determined that the desired IP address is the same as the IP address obtained from the request (“YES” at S1017), the operation determines that no error needs to be returned to the client apparatus 11 at S1018, and the operation ends. In such case, the URL including information regarding the desired address is not generated.

When it is determined that the desired IP address is different from the IP address obtained from the request (“NO” at S1017), the operation proceeds to S1019 to generate a URL including information regarding the desired IP address obtained at S1015. For example, the URL may include the IP address of “1234:1234::222”. S1020 returns the URL generated at S1019 with the “302 error” code to the client apparatus 11, and the operation ends. The client apparatus 11 may send a request using the URL being received from the server apparatus 10.

Further, the client apparatus 11 may store information regarding the desired address obtained by the server apparatus 10. Once the information regarding the desired IP address to be used for communication is stored, the client apparatus 11 may access the server apparatus 10 using the desired IP address.

Alternatively, the server apparatus 10 may store information regarding the desired address being obtained. Once the information regarding the desired IP address is stored, the server apparatus 10 may use such information to establish communication with the client apparatus 11 in a manner that satisfies the desired security level, even when a request sent from the client apparatus 11 contains no information regarding the desired address. For example, the client apparatus 11 may access the server apparatus 10 using a relative URL rather than a full URL to request a html document on the server apparatus 10. In another example, the client apparatus 11 may access the server apparatus 10 by specifying a host name of the server apparatus 10.

In this manner, the server apparatus 10 and the client apparatus 11 are able to always communicate in a manner that satisfies the desired security level. For example, as described above or below, the server apparatus 10 may obtain a desired IP address that satisfies the desired security level specified by the settings information, and cause the client apparatus 11 to communicate using the desired IP address. Since the security level is kept at the desired level, flow of the contents or information through the network may be easily managed, for example, by restricting access to the entire webpage or a selected webpage according to the desired security level. Further, since operation of obtaining the desired address may be automatically performed without human intervention, usability of the system may be kept relatively high.

Referring now to FIG. 12, operation of obtaining a desired server IP address having the version specified by the security settings information, performed by the address version converter 29 of FIG. 4, is explained according to an example embodiment of the present invention. The operation of FIG. 12 may be performed at S1003 of FIG. 10A.

S1201 analyzes the request received from the client apparatus 11 to obtain the version of an IP address currently used for communication between the server apparatus 10 and the client apparatus 11. More specifically, from the request received from the client apparatus 11, the URL generator 20 obtains the version of an IP address of the server apparatus 10 and the version of an IP address of the client apparatus 11. In this example, it is assumed that the IP addresses of the server apparatus 10 and the client apparatus 11 both have the version number of 4. The IPv4 address has a 32 bit address field, while the IPv6 address has a 128 bit address field with the security function.

S1202 refers to the security settings table 21 to obtain information indicating whether the version obtained at S1201 satisfies the desired security level. In this example, since it is assumed that the version of the IP address is 4, the “web version” information indicating whether IPv4 is opened or closed is obtained.

S1203 determines whether the version of the IP address obtained at S1201 satisfies the desired security level specified by the settings information, by referring to the “web version” information obtained at S1202. When it is determined that the “web version” information is open indicating that the version 4 is allowed (“YES” at S1203), the operation proceeds to S1204 to determine that no change in address version is necessary. When it is determined that the “web version” information is closed indicating that the version 4 is not allowed (“NO” at S1203), the operation proceeds to S1205.

S1205 refers to the security settings table 21 to obtain information indicating whether the forward option is selected such that the version of the IP address may be changed, for example, by referring to the “Web address version forward option” information. S1206 determines whether information obtained at S1205 indicates that the forward option is selected. When it is determined that the forward option is selected (“YES” at S1206), the operation proceeds to S1208. When it is determined that the forward option is not selected (“NO” at S1206), the operation proceeds to S1207 to return the “404 Not Found” error to the client apparatus 11.

S1208 refers to the security settings table 21 to obtain information indicating whether the version other than the version of the address obtained from the request satisfies the desired security level. In this example, it is assumed that the version 4 will be changed to the version 6, and the “web version” information indicating whether IPv6 is opened or closed is obtained.

S1209 determines whether the version of the IP address other than the version 4, specifically, the version 6, satisfies the desired security level specified by the settings information, by referring to the “web version” information obtained at S1208. When it is determined that the “web version” information indicates that the IPv6 is open (“YES” at S1209), the operation proceeds to S1210 to determine that the version of the address is changed from the version 4 to the version 6, and further to S1211 to return the determination result indicating that the version needs to be changed from the version 4 to 6. In such case, error is not returned. When it is determined that the “web version” information indicates that the IPv6 is closed (“NO” at S1209), the operation proceeds to S1207 to return the “404 Not Found error” to the client apparatus 11.

As the version of IP address may be easily changed according to the settings information, the security level of network communication, which may vary depending on the version of address, may be easily managed. For example, the settings information may be set so as to require the use of IP address having the version 6. This may simplify management of each apparatus or management of resource stored in each apparatus, as a part of the IPv6 address such as the interface ID may be generally derived from a MAC address of a host apparatus.

Referring now to FIGS. 13A and 13B, operation of determining whether the use of IPsec communication is required or preferred, performed by the secure settings request obtainer 30 of FIG. 4, is explained according to an example embodiment of the present invention. The operation of FIGS. 13A and 13B may be performed at S1011 of FIG. 10A.

IPsec, which is a suite of protocols for securing network communications by authenticating and/or encrypting an IP packet, operates at the network layer, which is the layer 3 of the OSI model having seven layers. Compared to the other security protocols such as SSL, which operates at the layer higher than the layer 3, IPsec may be used to protect layer 4 protocols such as TCP or UDP.

Further, the security level of IPsec communication may be set with respect to each one of a plurality of client apparatuses, for example, when the server apparatus communicates with the plurality of client apparatuses.

In this example, the server apparatus 10 and the client apparatus 11 may each be provided with one or more IP addresses previously set to use IPsec communication and one or more IP addresses previously set no to use IPsec communication. By switching between the IP address using IPsec communication and the IP address not using IPsec communication, the security level of communication between the server apparatus 10 and the client apparatus 11 may be switched, for example, between secure communication using IPsec and unsecure communication not using IPsec. For improved security, the settings information may be set so as to require or recommend the use of IPsec communication, thus protecting the contents or information stored in the server apparatus 10.

S1301 analyzes the request received from the client apparatus 11 to obtain an IP address of the client apparatus 11.

S1302 refers to the secure address settings table 22, which stores information regarding the settings of IPsec communication.

S1303 obtains information regarding the connection method currently used by the client apparatus 11 to communicate with the server apparatus 10. For example, referring to FIG. 6, the secure settings request obtainer 30 may select one of the security settings tables 1 to 4 that corresponds to the “local address” having the IP address currently assigned to the server apparatus 10 and the “remote address” having the IP address currently used by the client apparatus 11. Using the security settings table being obtained, the secure settings request obtainer 30 may obtain information regarding the currently-used connection method. Alternatively, the secure settings request obtainer 30 may obtain information regarding the currently-used connection method from the request being received from the client apparatus 11.

S1304 refers to the security settings table 21 of FIG. 5 to obtain information regarding the settings of IPsec communication (“IPsec option”), which is preferred or required by the server apparatus 10.

S1305 determines whether the IPsec option information, obtained at S1304, indicates that the use of IPsec communication is required. Referring back to FIG. 5, when the IPsec option is set to “IPsec only”, it is determined that the use of IPsec communication is required. When it is determined that the use of IPsec communication is required (“YES” at S1305), the operation proceeds to S1306 to compare the IPsec option information, obtained at S1304, with the connection method currently used, obtained at S1303. The operation further proceeds to S1307 to determine whether the current connection method uses IPsec communication specified by the IPsec option information. When it is determined that the current connection method uses IPsec communication (“YES” at S1307), it is determined that the current IP address remains unchanged, and the operation proceeds to S1308 to successfully end the process without error. When it is determined that the current connection method does not use IPsec communication (“NO” at S1307), the operation proceeds to S1309.

S1309 searches a desired IP address that uses IPsec communication from the search table of FIG. 11, which is generated for temporary use at S1002 of FIG. 10A.

S1310 determines whether the desired IP address that uses IPsec communication is found at S1309. When it is determined that the desired IP address using IPsec communication is found (“YES” at S1310), it is determined that the current IP address will be changed to the desired IP address that uses IPsec communication, and the operation proceeds to S1308 to successfully end the operation without error. When it is determined that the desired IP address using IPsec communication is not found (“NO” at S1310), the operation proceeds to S1311 to end the operation with error.

At S1305, when it is determined that the use of IPsec communication is not required (“NO” at S1305), the operation proceeds to S1313 to determine whether the use of IPsec communication is preferred by referring to the IPsec option information obtained at S1304. Referring back to FIG. 5, when the IPsec option is set to “IPsec priority”, it is determined that IPsec communication is preferred. In such case, the IP address that uses IPsec communication will be used as long as such IP address is available. When such IP address is not available, the IP address not using IPsec communication will be used. When it is determined that the IPsec option information indicates that the use of IPsec communication is preferred (“YES” at S1313), the operation proceeds to S1314 to compare the IPsec option information with the connection method currently used. The operation further proceeds to S1315 to determine whether the current connection method uses IPsec communication specified by the IPsec option information. When it is determined that the current connection method uses IPsec communication (“YES” at S1315), it is determined that the current IP address remains unchanged, and the operation proceeds to S1308 to successfully end the process without error. When it is determined that the current connection method does not use IPsec communication (“NO” at S1315), the operation proceeds to S1316.

S1316 searches a desired IP address that uses IPsec communication from the search table of FIG. 11, which is generated for temporary use at S1002 of FIG. 10A. When it is determined that the IP address using IPsec communication is found at S1316, it is determined that the current IP address will be changed to the desired IP address that uses IPsec communication, and the operation proceeds to S1308 to successfully end the operation. When it is determined that the desired IP address that uses IPsec communication is not found, it is determined that the current IP address remains unchanged, and the operation proceeds to S1308 to successfully end the operation.

At S1313, when it is determined that the use of IPsec communication is not preferred (“NO” at S1313), the operation proceeds to S1317 to determine whether either one of IPsec communication and non-IPsec communication is recommended for use. Referring back to FIG. 5, when the IPsec option is set to “IPsec/Non-IPsec”, it is determined that either one of IPsec communication and non-IPsec communication is recommended for use. When it is determined that either one of IPsec communication and non-IPsec communication is recommended (“YES” at S1317), it is determined that the current IP address remains unchanged, and the operation proceeds to S1308 to successfully end the operation. When it is determined that either one of IPsec communication and non-IPsec communication is not recommended (“NO” at S1317), the operation proceeds to S1318 to compare the IPsec option information with the connection method currently used. Referring back to FIG. 5, the IPsec option is assumed to set to “Non-IPsec only. The operation further proceeds to S1319 to determine whether the current connection method is set to non-IPsec communication. When it is determined that the current connection method is set to non-IPsec communication (“YES” at S1319), it is determined that the current IP address remains unchanged, and the operation proceeds to S1308 to successfully end the operation. When it is determined that the current connection method is not set to non-IPsec communication (“NO” at S1319), the operation proceeds to S1311 to end the operation with error.

In this manner as described above referring to FIGS. 13A and 13B, the security level of communications may be managed relatively easily by changing the settings of IPsec communication.

Referring to FIG. 15, operation of obtaining a desired IP address that uses the connection method satisfying the settings information, performed by the secure address obtainer 31 of FIG. 4, is explained according to an example embodiment of the present invention. The operation of FIG. 15 may be performed at S1014 of FIG. 10B.

S1501 analyzes the request received from the client apparatus 11 to obtain an IP address of the client apparatus 11.

S1502 obtains a host name corresponding to the IP address of the client apparatus 11, for example, by sending the request for name resolution to the DNS server 12.

S1503 requests the DNS sever 12 to obtain a list of a plurality of IP addresses each corresponding to the client apparatus 11.

S1504 selects one of the plurality of IP addresses from the list as a selected client IP address.

S1505 determines whether the selected client IP address is stored in the security address settings table 22. When it is determined that the selected client IP address is not found in the security address settings table 22 (“NO” at S1505), the operation proceeds to S1507. When it is determined that the selected client IP address is stored in the security address settings table 22 (“YES” at S1505), the operation proceeds to S1506 to add information regarding the selected client IP address to the search result table.

S1507 determines whether all client IP addresses in the list have been considered. When it is determined that all client IP addresses have not been considered (“NO” at S1507), the operation returns to S1504 to select the client IP address that has not been selected as a selected client IP address. When it is determined that all client IP addresses have been considered (“YES” at S1507), the operation proceeds to S1508.

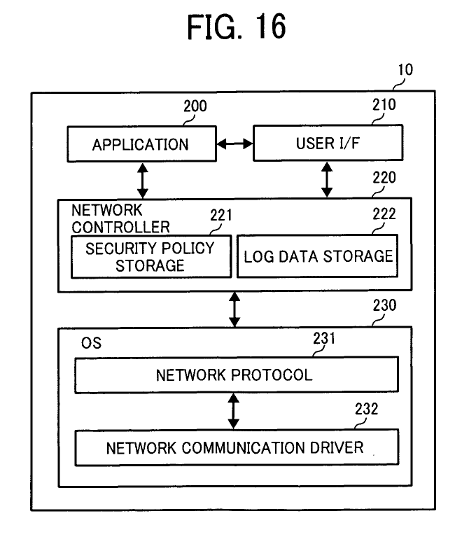

S1508 obtains information regarding the security level comparing function, which may be provided by the server apparatus 10. The security level comparing function is a function to select a desired IP address, for example, according to the level of security. The security level comparing function may be described below, for example, referring to FIGS. 16 to 27.

S1509 determines whether the security level comparing function is available for use. When it is determined that the security level comparing function is not available (“NO” at S1508), the operation proceeds to S1510 to select the client IP address firstly obtained from the search result table as a desired IP address, and the operation ends.

When it is determined that the security level comparing function is available (“YES” at S1508), the operation proceeds to S1511 to compare the security level of at least two IP addresses obtainable from the search result table. For example, the IP address listed first in the table and the IP address listed second in the table may be compared to determine one of the IP addresses having higher security level. The IP address being obtained as having higher security level is then compared with the IP address listed third in the table to determine one of the IP addresses having higher security level. By repeating this operation, the IP address having the highest security level may be selected from the search result table. With this selected IP address having the highest security level, the security level of network communications may be further improved.

S1512 selects the client IP address having the highest security level, which is obtained at S1511, as a desired IP address, and the operation ends.

Referring now to FIGS. 16 to 27, operation of obtaining a desired IP address, performed by the server apparatus 10, is explained according to an example embodiment of the present invention. Specifically, in this example, the security level comparing function, which may be provided by the server apparatus 10, is explained.

FIG. 16 illustrates a software structure of the server apparatus 10 shown in FIG. 2. The server apparatus 10 of FIG. 16 includes an application 200, a user I/F 210, a network controller 220, and an OS 230 including a network protocol 231 and a network driver 232. In this example, the network controller 220 includes a security policy storage 221 and a log data storage 222.

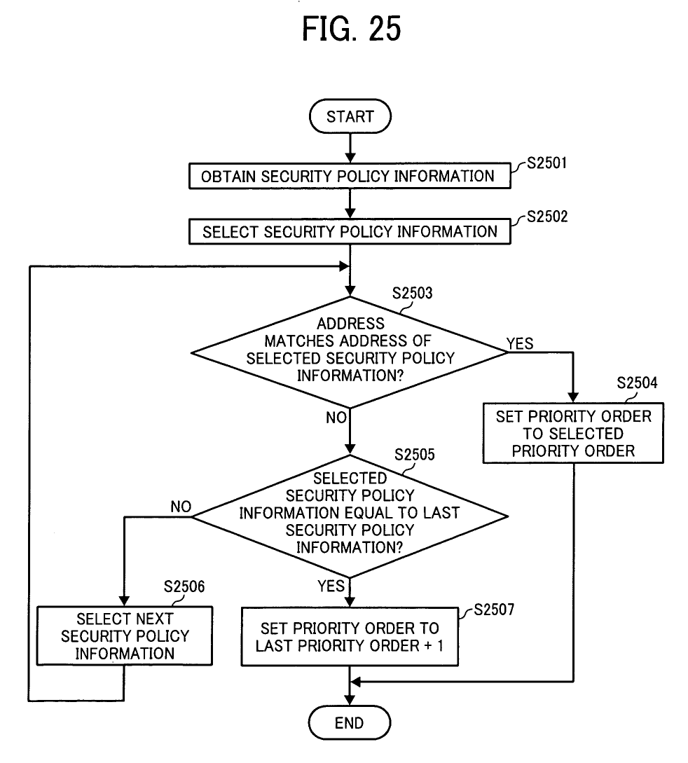

The security policy storage 221 stores security policy information, which may be set by the user through the user I/F 210. The network controller 220 controls communication according to the security policy information stored in the security policy storage 221. For example, referring to FIG. 18, the security policy storage 221 stores a plurality of items of security policy information each assigned with a predetermined priority order (“PRIORITY”). In this example, the priority order may be previously set such that the priority order having the lower numerical value will be preferred for use by the server apparatus 10. The priority order may be set, for example, as described below referring to FIG. 25. The security policy information includes information regarding the remote address, such as the IP address of the client apparatus 11 (“REMOTE ADDRESS”), and information regarding the connection method such as whether the use of IPsec communication is preferred or required (“COMMUNICATION”). For example, referring to the table shown in FIG. 18, when the server apparatus 10 communicates with the client apparatus 11 according to the security policy assigned with the priority order 1, the IP address “2001:2:3::3” will be assigned to the client apparatus 11 and IPsec communication is used.

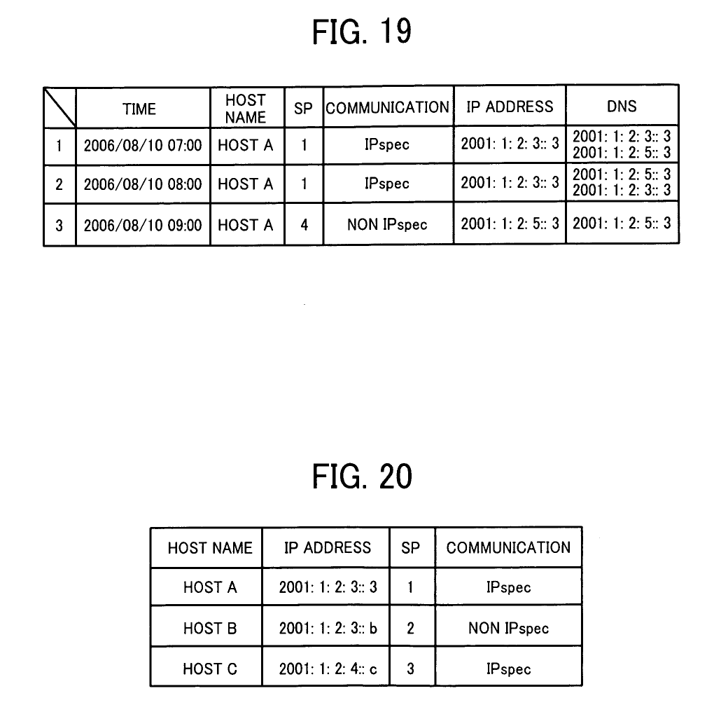

The log data storage 222 stores log data, which may be obtained as information regarding previous communication performed by the server apparatus 10. For example, referring to FIG. 19, the log data storage 222 may store a plurality of kinds of log data, each of which includes information regarding the time when connection is made (“TIME”), information regarding the host name (“HOST NAME”), information regarding the priority order assigned to the security policy information that corresponds to the communication being performed (“SP”), information regarding the connection method such as whether IPsec communication is used (“COMMUNICATION”), information regarding a client address used for communication such as a client IP address (“IP ADDRESS”), and information regarding one or more client IP addresses obtained from the DNS server 12 (“DNS”).

Still referring to FIG. 19, the first log data listed first indicates that the server apparatus 10 obtained two client IP addresses “2001:1:2:3::3” and “2001:1:2:5::3” in this order from the DNS server 12, and communicated with the client apparatus 11 using the client IP address “2001:1:2:3::3” using IPsec communication at the connection time of 2006/08/10 07:00 to be incompliance with the security policy having the priority order of 1. The second log data listed second indicates that the server apparatus 10 obtained two client IP addresses “2001:1:2:5::3” and “2001:1:2:3::3” in this order from the DNS server 12, and communicated with the client apparatus 11 using the IP address “2001:1:2:3::3” using IPsec communication at the connection time of 2006/08/10 08:00 to be in compliance with the security policy having the priority order of 1. The third log data listed third indicates that the server apparatus 10 obtained one IP address “2001:1:2:5::3” from the DNS server 12, and communicated with the client apparatus 11 using the IP address “2001:1:2:5::3” not using IPsec communication at the connection time of 2006/08/10 09:00 in compliance with the security policy having the priority order of 4.

In this example, the third log data may be obtained when one of the first and second routers 13 and 14 shown in FIG. 2 has a trouble such that the IP address “2001:1:2:3::3” is not available for use, thus deleting information regarding the IP address “2001:1:2:3::3” from the DNS server 12. The log data may be used to analyze the trouble in communication.

With the log data being stored, the user may be able to obtain information regarding previous communication, such as information regarding the use of IPsec communication or the priority order of security policy being used. Based on the information being obtained, the user may be able to review the settings information to determine whether the settings information is set so as to satisfy the actual need of the user. Further, the user may be able to detect an error which may be caused by the device, such as the router.

Further, in this example, the log data storage 222 may store a warning table, such as a warning table shown in FIG. 20, which may be used by the server apparatus 10 to determine whether warning should be given to the use at the server apparatus 10 or the client apparatus 11. The warning table of FIG. 20 includes information regarding the host name (“HOST NAME”), information regarding the client IP address used for communication (“IP ADDRESS”), information regarding the security policy priority order (“SP”), and information regarding the connection method such as whether IPsec communication is used (“COMMUNICATION”). In this example, selected information may be copied from the log data shown in FIG. 19 onto the warning table of FIG. 20, for example, when the security level of communication between the server apparatus 10 and the client apparatus 11 is changed. For example, the log data may be copied when the security level is lowered due to the change in client IP address obtained from the DNS server 12. Specifically, as described below, the log data may be copied when the change from IPsec communication to Non-IPsec communication is detected or when the change in the security policy priority order is detected.

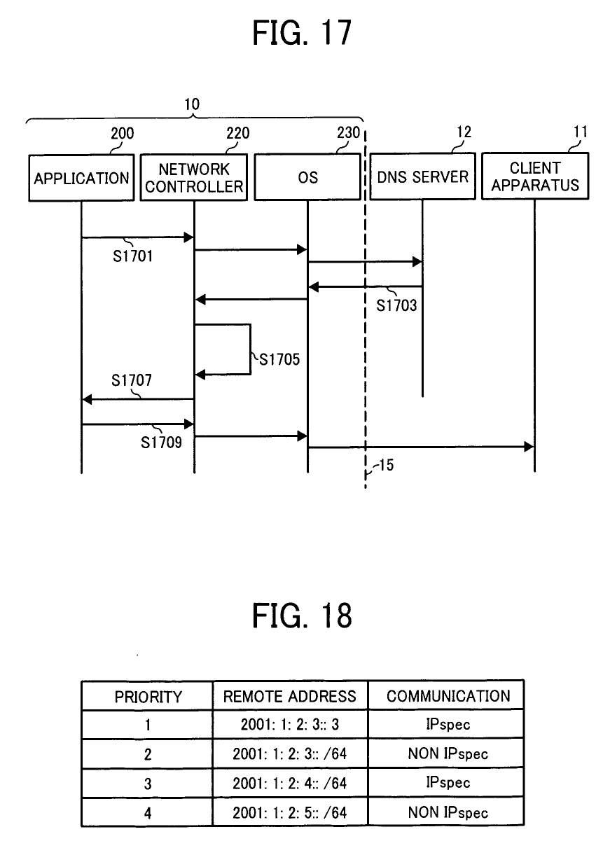

As illustrated in FIG. 17, in example operation, at S1701, the application 200 of the server apparatus 10 sends a name resolution request to the DNS server 12 through the network controller 220 and the OS 230. For example, the application 200 may ask the DNS server 12 to obtain one or more client IP addresses each corresponding to the host name “hostA”.

At S1703, the DNS server 12 sends a list of a plurality of client IP addresses each corresponding to the host name “hostA” to the network controller 220 through the OS 230 via the network 15.

At S1705, the network controller 220 selects one of the plurality of client IP addresses from the list as a desired client IP address. At S1707, the network controller 220 sends the desired client IP address to the application 200.

At S1709, the application 200 of the server apparatus 10 communicates with the client apparatus 11 with the desired client IP address.

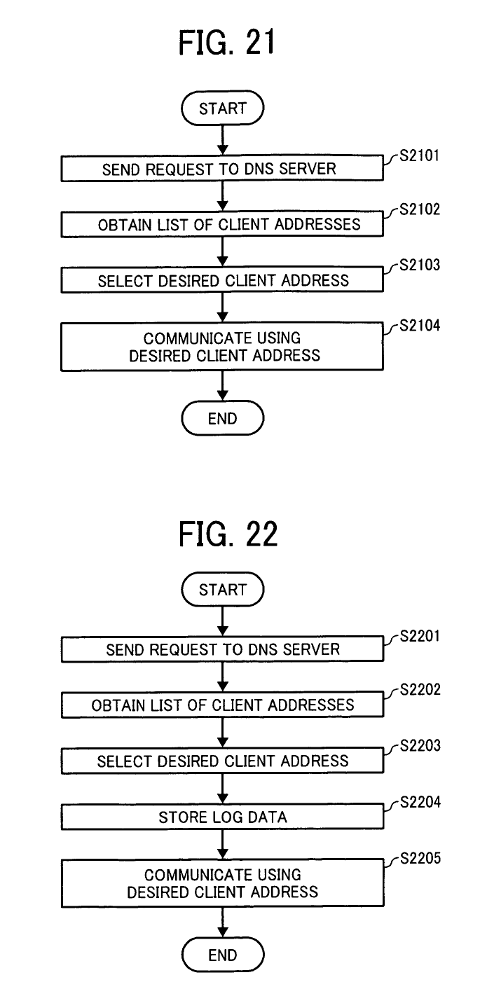

Referring to FIG. 21, operation of obtaining a desired IP address of the client apparatus 11, performed by the server apparatus 10 shown in FIG. 16, is explained according to an example embodiment of the present invention.

At S2101, the application 200 sends a name resolution request to the DNS server 12, which requests the DNS server 12 to obtain one or more client IP addresses corresponding to the host name of the client apparatus 11. The DNS server 12 returns a list of a plurality of client IP addresses to the server apparatus 10.

At S2102, the network controller 220 obtains the list of the plurality of client IP addresses from the DNS server 12.

At S2103, the network controller 220 selects one of the plurality of client IP addresses from the list, and sends the selected client IP address to the application 200 as a desired client IP address.

At S2104, the application 200 communicates with the client apparatus 11 using the desired client IP address, and the operation ends.

Referring to FIG. 22, operation of obtaining a desired IP address of the client apparatus 11, performed by the server apparatus 10 shown in FIG. 16, is explained according to an example embodiment of the present invention.

At S2201, the application 200 sends a name resolution request to the DNS server 12, which requests the DNS server 12 to obtain one or more client IP addresses corresponding to the host name of the client apparatus 11. The DNS server 12 returns a list of a plurality of client IP addresses to the server apparatus 10.

At S2202, the network controller 220 obtains the list of the plurality of client IP addresses from the DNS server 12.

At S2203, the network controller 220 selects one of the plurality of client IP addresses from the list, and sends the selected client IP address to the application 200 as a desired client IP address.

At S2204, the log data storage 222 stores various information including, for example, time, host name, security policy priority order, IPsec communication settings, selected IP address, and the list of IP addresses obtained from the DNS server 12, as log data.

At S2205, the application 200 communicates with the client apparatus 11 using the desired client IP address, and the operation ends.

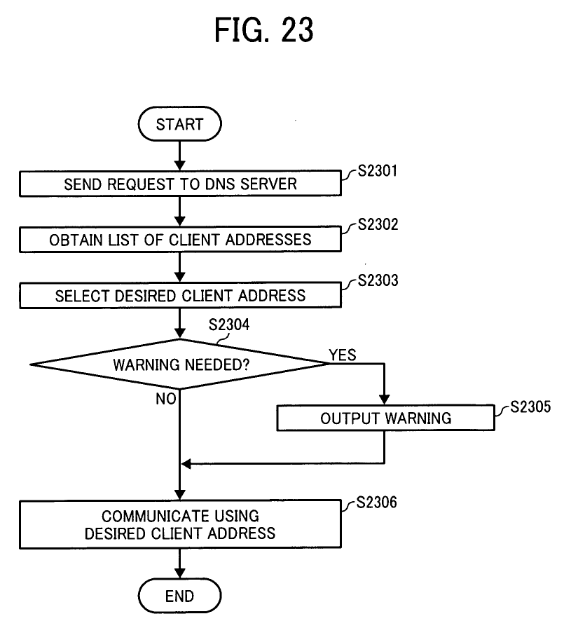

Referring to FIG. 23, operation of obtaining a desired IP address of the client apparatus 11, performed by the server apparatus 10 shown in FIG. 16, is explained according to an example embodiment of the present invention.

At S2301, the application 200 sends a name resolution request to the DNS server 12, which requests the DNS server 12 to obtain one or more client IP addresses corresponding to the host name of the client apparatus 11. The DNS server 12 returns a list of the plurality of client IP addresses to the server apparatus 10.

At S2302, the network controller 220 obtains the list of the plurality of client IP addresses from the DNS server 12.

At S2303, the network controller 220 selects one of the client IP addresses from the list, and sends the selected client IP address to the application 200 as a desired client IP address.

At S2304, the network controller 220 determines whether the selection of the desired client IP address made at S2303 is subjected to warning. When it is determined that the selection of S2303 is subjected to warning (“YES” at S2304), the operation proceeds to S2305 to output warning. When it is determined that the selection of S2303 is not subjected to warning (“NO” at S2304), the operation proceeds to S2306 without outputting warning.

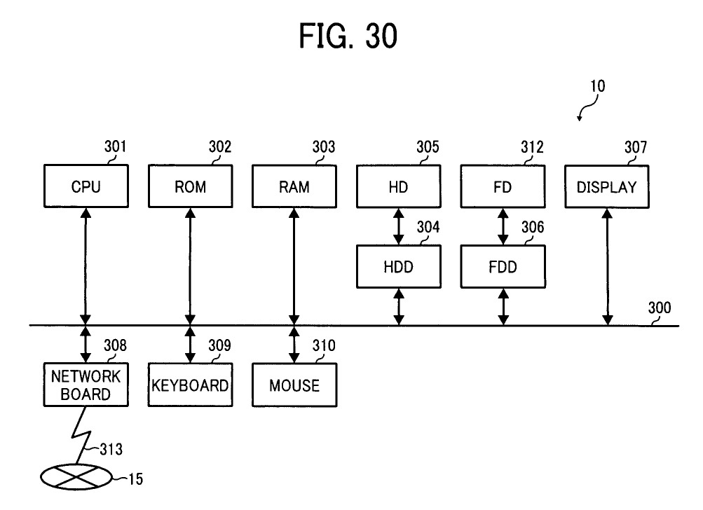

In one example, the user I/F 210 may cause a display 107 (FIG. 30), which may be provided with the server apparatus 10, to display a warning message. In another example, the user I/F 210 may cause a speaker, which may be provided with the server apparatus 10, to output a warning sound or message. Alternatively, the network controller 220 may cause the server apparatus 10 to send an email containing a warning message to the client apparatus 11 via the network 15. Alternatively, the network controller 220 may cause the server apparatus 10 to send a html document containing a warning message to the client apparatus 11 to cause the client apparatus 11 to display the warning message to the user.

At S2306, the application 200 communicates with the client apparatus 11 using the desired client IP address, and the operation ends.

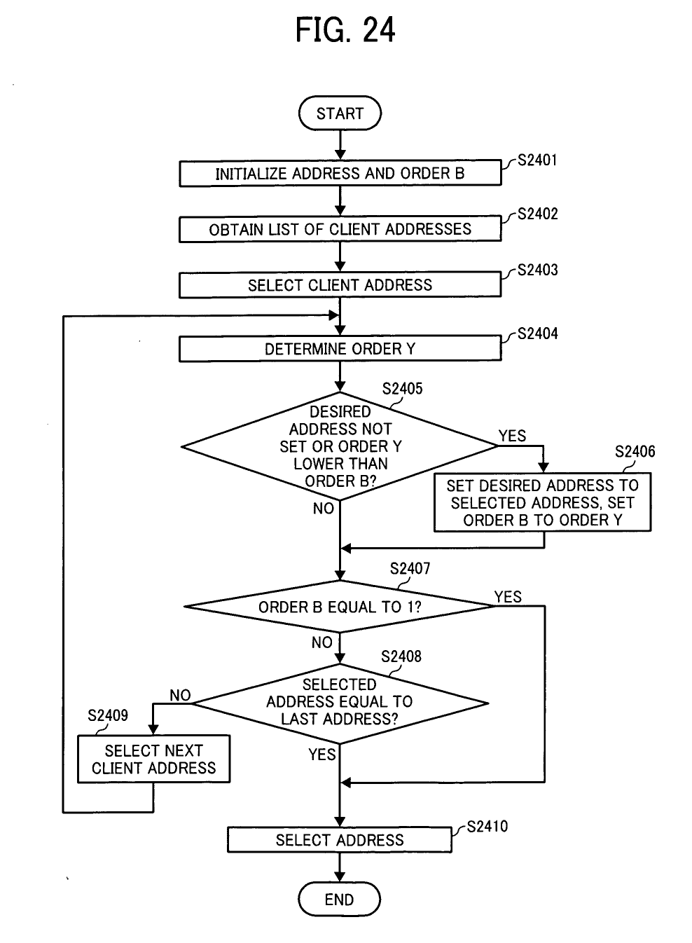

Referring to FIG. 24, operation of selecting a desired IP address from the list of a plurality of IP addresses is explained according to an example embodiment of the present invention. The operation of FIG. 24 may be performed at any one of S2103 of FIG. 21, S2203 of FIG. 22, and S2303 of FIG. 23.

S2401 initializes the setting of the desired client IP address A, and the setting of the security policy priority order B that corresponds to the desired client IP address A.

S2402 obtains a plurality of client IP addresses A1 to Am from the DNS server 12, for example, by sending a name resolution request as described above.

S2403 selects one client IP address Ax from the plurality of client IP addresses A1 to Am.

S2404 determines a priority order y, which is assigned to the selected client IP address Ax, for example, as described below referring to FIG. 25.

S2405 determines whether the desired client IP address A has been set. When it is determined that the desired client IP address A has not been set, the operation proceeds to S2406 to set the desired client IP address A to the selected client IP address Ax. Alternatively, when the priority order B has been set, S2405 may determine whether the numerical value indicated by the priority order y of the selected client IP address Ax is less than the numerical value indicated by the priority order B. When it is determined that the numerical value of the priority order y is less than the numerical value of the priority order B, the operation proceeds to S2406 to set the priority order B to be equal to the numerical value of the priority order y.

S2407 determines whether the priority order B is equal to 1, or the value of the priority order indicating the highest security level. When it is determined that the priority order B is not equal to 1 (“NO” at S2407), the operation proceeds to S2408 to determine whether the selected client IP address Ax is equal to the client IP address Am, which is considered last. When it is determined that the selected client IP address Ax is not equal to the client IP address Am (“NO” at S2408), the operation proceeds to S2409 to select a next client IP address from the plurality of client IP addresses, and returns to S2404. When it is determined that the priority order B is equal to 1 (“YES” at S2407), the operation proceeds to S2410 to set the desired client IP address A to be equal to the selected client IP address Ax, and the operation ends.

At S2408, when it is determined that the client IP address Ax is equal to the client IP address Am (“YES” at S2408), the operation proceeds to S2410 to select the client IP address Ax as a desired client IP address, and the operation ends.

Referring to FIG. 25, operation of obtaining the security policy priority order y is explained according to an example embodiment of the present invention. The operation of FIG. 25 may be performed at S2404 of FIG. 24.

S2501 reads out security policy information from the security policy storage 221 for each one of the security policy priority orders 1 to n.

S2502 selects one of the priority orders 1 to n, in the order from 1 to n, as a selected priority order z, and obtains security policy information regarding the selected priority order z. For the descriptive purpose, the security policy information for the security policy priority order z may be referred to as the security policy information SPz, with z being equal to 1 to n.

S2503 determines whether the client IP address Ax, which is obtained at S2403 of FIG. 24, matches the client IP address specified by the security policy information SPz. When it is determined that the client IP address Ax matches the client IP address specified by the security policy information SPz (“YES” at S2503), the operation proceeds to S2504 to set the priority order y to be equal to the selected priority order z. When it is determined that the client IP address Ax does not match the client IP address specified by the security policy information SPz (“NO” at S2503), the operation proceeds to S2505.

S2505 determines whether the security policy information SPz is equal to the security policy information SPn, which will be considered last. When it is determined that the security policy information SPz is not equal to the security policy information SPn (“NO” at S2505), the operation proceeds to S2506 to select security policy information SPz+1, which is to be considered next, and further to S2503 to determine whether the selected IP address Ax matches the IP address specified by the security policy information SPz+1.

When it is determined that the security policy information SPz is equal to the security policy information SPn (“YES” at S2505), the priority order y is set to n+1, and the operation ends.

As described above referring to FIGS. 24 and 25, the server apparatus 10 may be provided with the function of switching a selection method between a selection method of selecting the desired IP address having the highest security level and a selection method of selecting the desired IP address firstly obtained.

For example, when all or at least two IP addresses obtained from the DNS server 12 have different security levels, the server apparatus 10 may select the IP address having the highest security level.

In another example, when all or at least two IP addresses obtained from the DNS server 12 have the same security levels, the server apparatus 10 may select the IP address firstly obtained.

By combining the above-described selection methods, the desired address that satisfies the desired security level may be obtained more efficiently, with reduced processing time.

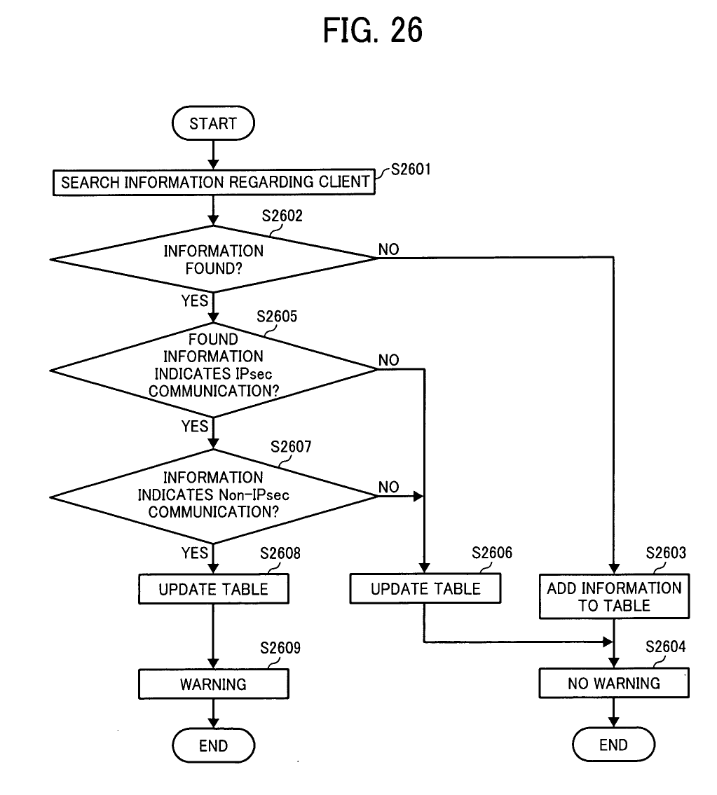

Referring now to FIG. 26, operation of determining whether the selection of desired IP address is subjected to warning is explained according to an example embodiment of the present invention. The operation of FIG. 26 may be performed at S2304 of FIG. 23.

S2601 refers to the warning table stored in the log data storage 222, such as the warning table of FIG. 20, to obtain information regarding the client apparatus 11, for example, by checking the IP address information.

S2602 determines whether any information regarding the client apparatus 11 is found in the warning table of FIG. 20. When it is determined that no information is found (“NO” at S2602), the operation proceeds to S2603 to add information regarding the communication to be performed using the desired address, to the warning table. Referring to FIG. 20, the information to be added may include information regarding the host name, information regarding the IP address, information regarding the security policy priority order, and information regarding the connection method such as whether IPsec communication is used. The operation further proceeds to S2604 to determine that the selection of IP address is not subjected to warning, and the operation ends.

At S2602, when it is determined that information regarding the client apparatus 11 is found in the warning table (“YES” at S2602), the operation proceeds to S2605 to determine whether the found information regarding the client apparatus 11 indicates that IPsec communication is used. When it is determined that the found information does not indicate the use of IPsec communication (“NO” at S2605), the operation proceeds to S2606 to update information stored in the warning table with the information regarding the communication to be performed using the desired address. The operation further proceeds to S2604 to determine that the selection of IP address is not subjected to warning, and the operation ends.

When it is determined that the found information indicates the use of IPsec communication (“YES” at S2605), the operation proceeds to S2607 to determine whether information regarding the communication to be performed using the desired address indicates the use of non-IPsec communication. When it is determined that the use of IPsec communication is indicated (“NO” at S2607), the operation proceeds to S2606 to update the warning table with the information regarding the communication to be performed using the desired address, and further to S2604 to determine that the selection of IP address is not subjected to warning. When it is determined that the use of non-IPsec communication is indicated (“YES” at S2607), the operation proceeds to S2608 to update the warning table with the information regarding the communication to be performed using the desired address. The operation further proceeds to S2609 to determine that the selection of IP address is subjected to warning, and the operation ends.

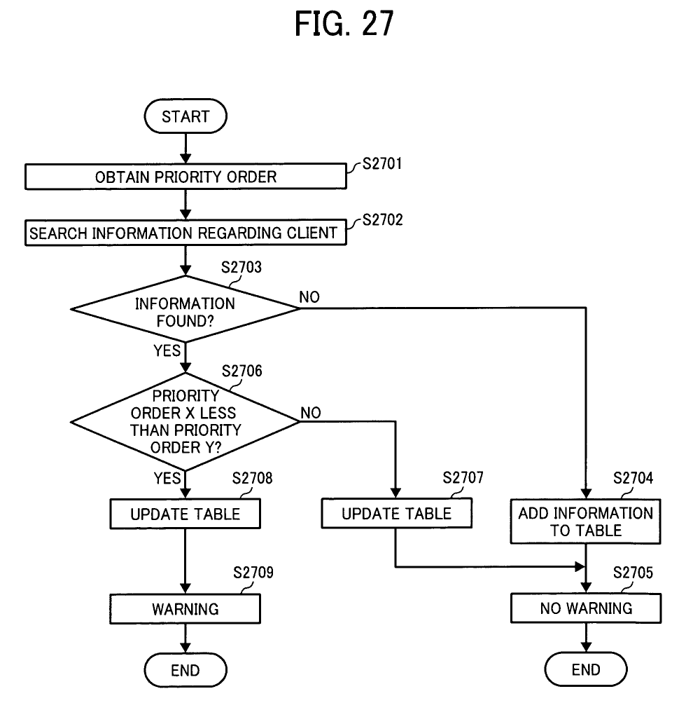

Referring now to FIG. 27, operation of determining whether the selection of desired IP address is subjected to warning is explained according to an example embodiment of the present invention. The operation of FIG. 27 may be performed at S2304 of FIG. 23.

S2701 obtains the security policy priority order y of the selected IP address, for example, as described above referring to FIG. 25.

S2702 refers to the warning table stored in the log data storage 222, such as the warning table of FIG. 20, to obtain information regarding the client apparatus 11, for example, by checking the IP address information.

S2703 determines whether any information regarding the client apparatus 11 is obtained at S2702. When it is determined that no information is obtained (“NO” at S2703), the operation proceeds to S2704 to add information regarding the communication to be performed using the desired address to the warning table. The operation further proceeds to S2705 to determine that the selection of IP address is not subjected to warning, and the operation ends.

At S2703, when it is determined that information regarding the client apparatus 11 is obtained (“YES” at S2703), the operation proceeds to S2706 to compare the priority order y corresponding to the communication to be performed and the priority order x of the security policy information being obtained at S2702, and determine whether the numerical value x is less than the numerical value y. When it is determined that the numerical value x is not less than the numerical value y (“NO” at S2706), the operation proceeds to S2707 to update the warning table with the information regarding the communication to be performed using the desired address. The operation further proceeds to S2705 to determine that the selection of IP address is not subjected to warning, and the operation ends.

When it is determined that the numerical value x is less than the numerical value y (“YES” at S2706), the operation proceeds to S2708 to update the warning table with the information regarding the communication to be performed using the desired address. The operation further proceeds to S2709 to determine that the selection of IP address is subjected to warning, and the operation ends.

As described above referring to FIGS. 26 and 27, the server apparatus 10 may determine to output warning when the change in IP address causes the security level to be lowered. For example, the server apparatus 10 may determine to output warning when the connection method changes from the connection method using IPsec communication to the connection method not using IPsec communication. In another example, the server apparatus 10 may determine to output warning when the priority order changes from the priority order having the smaller value to the priority order having the greater value. The warning may be output in various ways according to the default settings or according to the user preference. Through the warning, the server apparatus 10 may ask the user whether reviewing the settings information such as security policy information or registration information of the DNS server 12 is necessary. This may lower the risk of communicating in a manner that does not satisfy the actual need of the user.

As described above, the server apparatus 10 is capable of managing access from the client apparatus 11 such that the server apparatus 10 and the client apparatus 11 are able to communicate while maintaining the desired security level, for example, by restricting access to the entire resource provided by the server apparatus 10 according to the settings information previously set for the server apparatus 10. In another example, one or more webpages provided by the server apparatus 10 may require the client apparatus 10 to access the server apparatus 10 in a manner different from the manner specified by the settings information previously set for the server apparatus 10.

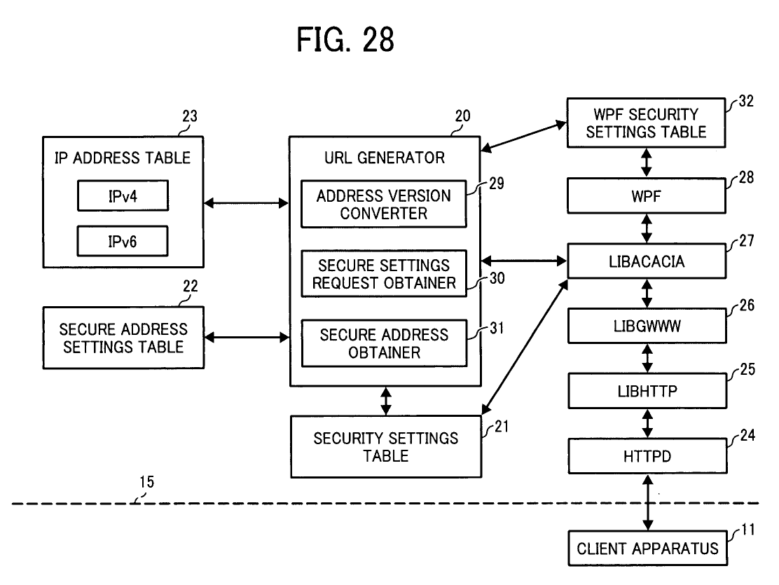

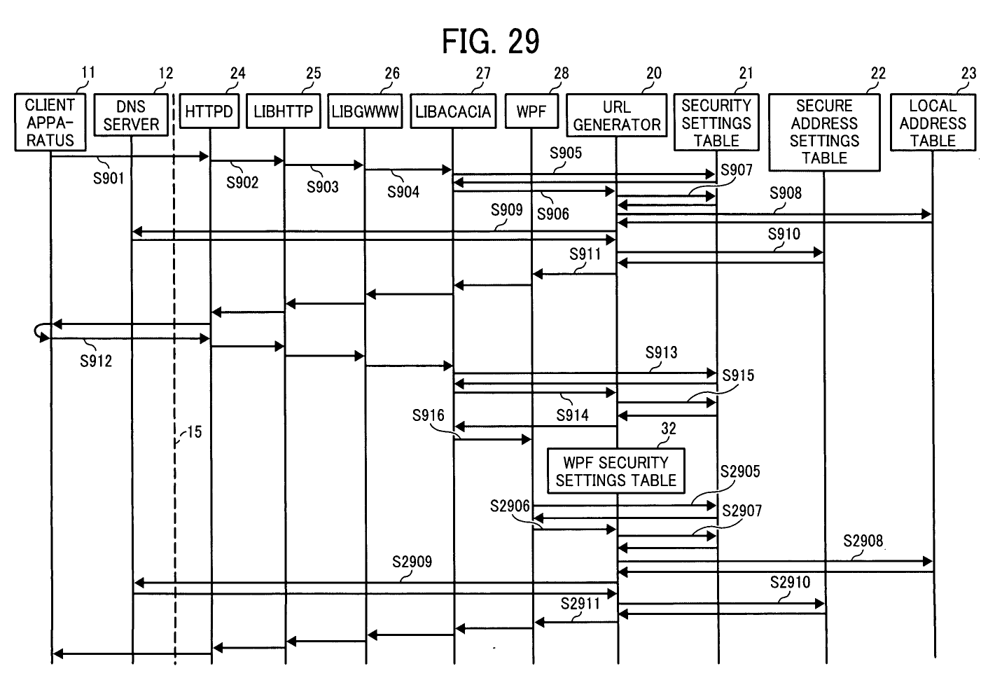

FIGS. 28 and 29 illustrate an example case in which a desired IP address is obtained according to the settings information previously set for the server apparatus 10, and a desired IP address is obtained according to at least one webpage of a plurality of webpages stored in the server apparatus 10.

FIG. 28 illustrates a software structure of a selected portion of the server apparatus 10 according to an example embodiment of the present invention. The software structure shown in FIG. 28 is substantially equal to the software structure shown in FIG. 4. The differences include the addition of a WPF security settings table 32.

The WPF security settings table 32 may store settings information, which may be previously set by default or according to the user preference for each webpage of a plurality of webpages provided by the server apparatus 10. The URL generator 20 may obtain a desired address to be used for communication that satisfies the settings information stored in the WPF security settings table 32 in a substantially similar manner as described above, and generate a URL including address information regarding the desired address.

Referring to FIG. 29, operation of obtaining a desired IP address that satisfies the desired security level is explained according to an example embodiment of the present invention. The operation of FIG. 29 is substantially similar to the operation of FIG. 9. The differences include the addition of S2905 to S2911.

In prior to S2905, the server apparatus 10 obtains a desired address that satisfies the desired security level specified by the settings information previously set for the server apparatus 10. Using the desired address, the client apparatus 11 establishes communication with the server apparatus 10. In some cases, a webpage accessed by the user at the client apparatus 10 may contain a link to another webpage, which requires the security level higher than the security level specified by the settings information of the server apparatus 10. In such case, the server apparatus 10 may perform the following steps to obtain a desired address that satisfies the desired security level specified by the setting information previously set for the webpage to be linked.

At S2905, the WPF 28 may refer to security settings information stored in the WPF security settings table 32 to determine whether the security level needs to be managed for a selected webpage in a substantially similar manner as described above referring to S905 of FIG. 9.

When the security settings information indicates that security management is necessary, at S2906, the WPF 28 requests the URL generator 20 to determine whether the IP address being obtained satisfies the desired security level specified by the settings information stored in the WPF security settings table 32.

At S2907, the URL generator 20 refers to the WPF security settings table 32 to determine the security level specified by the security settings information. At S2908, the URL generator 20 may obtain a desired server IP address in a substantially similar manner as described above referring to S908 of FIG. 9.

At S2909, the URL generator 20 may request the DNS server 12 to obtain a plurality of client IP addresses each corresponding to the client apparatus 11.

At S2910, the URL generator 20 may obtain the desired IP address to be used for communication, in a substantially similar manner as described above referring to S910 of FIG. 9.

At S2911, the URL generator 20 generates a URL having address information regarding the desired address, and sends a response including the URL to the client apparatus 11 without the error code.

Alternatively, when the settings information indicates that access to the selected webpage by the client apparatus 11 is prohibited, the URL generator 20 may return the 404 error code to the client apparatus 11.

As described above referring to FIGS. 28 and 29, the security level of network communications may be managed page by page, thus increasing the usability.

Any one of the server apparatus 10 and the client apparatus 11, shown in FIG. 2, may be implemented in various ways.

Referring to FIG. 30, a hardware structure of the server apparatus 10 is explained according to an example embodiment of the present invention. The server apparatus 10 includes an central processing unit (CPU) 301, a read only memory (ROM) 302, a random access memory (RAM) 303, a hard disk drive (HDD) 304, a hard disk (HD) 305, a flexible disk drive (FDD) 306, a floppy disk (FD) 312, a display 307, a network board 308, a keyboard 309, and a mouse 310, which are connected or coupled with one another via a bus 300. The server apparatus 10 may not be provided with all devices shown in FIG. 30, as long as the CPU 301 and a memory, such as the ROM 302 and the RAM 303, are provided.

The CPU 301 controls operation of the server apparatus 10. The ROM 302 stores various kinds of computer program including a program, which causes the server apparatus 10 to perform operation of controlling network communications, such as causing the client apparatus 11 to access using a desired address that satisfies the desired security level specified by the settings information. The RAM 303 may function as a work area of the CPU 301, or an area to store various data including, for example, the settings information specifying the desired security level, information regarding a communication security level that may be dependent on an address or a connection method to be used for communication, log information regarding previously performed communication, etc. In this example, the RAM 303 may be volatile and/or involatile depending on one or more functions to be provided by the RAM 303. The HDD 304 may control operation of reading or writing data from or onto the HD 105 under control of the CPU 301. The HD 305 may store data such as a plurality of webpages. The FDD 306 may control operation of reading or writing data from or onto the FD 312 under control of the CPU 301. The FD 312, which is removable, may store data written by the FDD 306.

The display 307 may display various data including, for example, a curser, menu, window, text data or image data. The keyboard 309 may input various data, such as a user instruction provided by a user. The mouse 310 may be used to input various data, such as a user instruction, for example, by moving the curser displayed on the display 307, selecting the menu displayed on the display 307, or opening and/or closing the window displayed on the display 307. As described above, the display 307 may output warning to the user when the security level is changed. Any one of the keyboard 309 and the mouse 310 may be used to input various information, such as the settings information.

The network board 308, which may function as a network interface, connects the server apparatus 10 to the network 15 via a communication cable 313. For example, the network board 308 may allow the server apparatus 10 to communicate with one or more client apparatuses 11 via the network 15.

The client apparatus 11 may have a hardware structure similar to the hardware structure shown in FIG. 30.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

What is claimed is:

1. A communication apparatus, comprising:
a network interface configured to receive a request generated by a counterpart apparatus, the request including address information regarding an address currently used for communication between the communication apparatus and the counterpart apparatus;
a network controller configured to determine whether the address information obtainable from the request satisfies a desired security level specified by settings information to generate a determination result, obtain a desired address that satisfies the desired security level when the determination result indicates that the address information does not satisfy the desired security level, and send a response including address information regarding the desired address being obtained to the counterpart apparatus.

2. The apparatus of claim 1, wherein the address information includes information regarding a version of the currently used address, and wherein the settings information includes information regarding a version of the desired address,
the determination result being generated based on whether the version of the currently used address satisfies the desired security level specified by the information regarding the version of the desired address.

3. The apparatus of claim 1, wherein the settings information includes information indicating regarding the use of IPsec communication,
the determination result being generated based on whether the address information regarding the currently used address satisfies the desired security level specified by the information regarding the use of IPsec communication.

4. The apparatus of claim 3, wherein the desired address includes at least one of:
a first desired address assigned to the communication apparatus and selected from one or more first addresses being obtained from the communication apparatus; and
a second desired address assigned to the counterpart apparatus and selected from one or more second addresses being obtained from at least one of the communication apparatus and the outside of the communication apparatus.

5. The apparatus of claim 4, further comprising:
a storage configured to store information regarding a communication security level indicating the security level of communication to be performed using the desired address,
wherein the network controller is configured to select, when the desired address includes a plurality of desired addresses, one of the plurality of desired addresses based on the communication security level.

6. The apparatus of claim 1, wherein the settings information includes at least one of:
first settings information previously set for the entire resource of the communication apparatus; and
second settings information previously set for at least a portion of the entire resource provided by the communication apparatus.

7. The apparatus of claim 1, wherein:
the communication apparatus is further configured to store the address information regarding the desired address for subsequent communication with the counterpart apparatus.

8. The apparatus of claim 4, further comprising:
a first storage configured to store a plurality of kinds of security policy information each assigned with a priority order, the security policy information including information regarding a communication security level,
wherein the network controller is configured to select, when the desired address includes a plurality of desired addresses, one of the plurality of desired addresses based on the priority order to obtain a selected desired address.

9. The apparatus of claim 8, wherein:
the network controller is further configured to select, when the selected desired address includes a plurality of selected desired addresses, one of the plurality of selected desired addresses based on information regarding an order in which the desired address is obtained.

10. The apparatus of claim 8, further comprising:
a second storage configured to store log information regarding communication previously performed between the communication apparatus and the counterpart apparatus,
wherein the log information includes information regarding a communication security level indicating the security level of the previously performed communication.

11. The apparatus of claim 10, wherein:
the network controller is further configured to compare, when the desired address is obtained, the communication security level indicating the security level of communication to be performed using the desired address with the communication security level indicating the security level of the previously performed communication to generate a comparison result, and to determine whether to output warning based on the comparison result.

12. A method of controlling communication between a communication apparatus and a counterpart apparatus, the method comprising:
receiving a request generated by the counterpart apparatus, the request including address information regarding an address currently used for communication between the communication apparatus and the counterpart apparatus;
determining whether the address information obtainable from the request satisfies a desired security level specified by settings information to generate a determination result;
obtaining a desired address that satisfies the desired security level when the determination result indicates that the address information does not satisfy the desired security level; and
sending a response to the counterpart apparatus, the response including address information regarding the desired address being obtained.

13. The method of claim 12, wherein the determining whether the address information obtainable from the request satisfies a desired security level specified by settings information comprises:
obtaining information regarding the use of IPsec communication from the settings information,
the determination result being generated based on whether the address information regarding the currently used address satisfies the desired security level specified by the information regarding the use of IPsec communication.

14. The method of claim 12, further comprising:
storing information regarding a communication security level indicating the security level of communication to be performed using the desired address, wherein:
the obtaining a desired address that satisfies the desired security level comprises:
selecting, when the desired address includes a plurality of desired addresses, one of the plurality of desired addresses based on the communication security level.

15. The method of claim 12, further comprising:
storing a plurality of kinds of security policy information each assigned with a priority order, the security policy information including information regarding a communication security level, wherein:
the obtaining a desired address that satisfies the desired security level comprises:
selecting, when the desired address includes a plurality of desired addresses, one of the plurality of desired addresses based on the priority order.

16. The method of claim 15, further comprising:
storing log information regarding communication previously performed between the communication apparatus and the counterpart apparatus, wherein the log information includes information regarding a communication security level indicating the security level of the previously performed communication;
comparing, when the desired address is obtained, the communication security level indicating the security level of communication to be performed using the desired address with the communication security level indicating the security level of the previously performed communication to generate a comparison result; and
determining whether to output warning based on the comparison result.

17. A communication system, comprising:
a server apparatus; and
a client apparatus coupled to the server apparatus via a network and configured to generate a first request, the first request including address information regarding an address currently used for communication with the server apparatus, wherein
the server apparatus is configured to determine, when the first request is received, whether the address information obtainable from the request satisfies a desired security level specified by settings information to generate a determination result, obtain a desired address that satisfies the desired security level when the determination result indicates that the address information does not satisfy the desired security level, and send a response to the client apparatus, the response including address information regarding the desired address being obtained, and wherein:
the server apparatus is configured to send a second request including the address information regarding the desired address.

18. The system of claim 17, further comprising:
a DNS server coupled to the server apparatus via the network and configured to send one or more client addresses to the server apparatus, and wherein:
the desired address includes a desired client address selected from the one or more client addresses being obtained from the DNS server.

19. The system of claim 17, wherein:
the server apparatus is further configured to compare, when the desired address is obtained, a communication security level indicating the security level of communication to be performed using the desired address, with a communication security level indicating the security level of communication previously performed with the client apparatus to generate a comparison result, and send warning based on the comparison result to the client apparatus, and wherein:
the client apparatus is further configured to output warning to a user.

20. The system of claim 17, wherein the client apparatus is further configured to store the address information regarding the desired address for subsequent communication with the server apparatus.
